(19) United States
(12) Patent Application Publication
(10) Pub. No.: US 2026/0341566 A1
(43) Pub. Date: Oct. 29, 2026

(54) DISPLACEMENT SYSTEM AND MOVER THEREFOR

(71) Applicant: PLANAR MOTOR INCORPORATED, Vancouver (CA)

(72) Inventors: Jesse LI, Vancouver (CA); Graham WILLIAMSON, Vancouver (CA)

(21) Appl. No.: 19/155,408

(22) PCT Filed: Feb. 14, 2024
(86) PCT No.: PCT/CA2024/050189

§ 371 Date: Aug. 11, 2025

Related U.S. Application Data
(60) Provisional application No. 63/445,582, filed on Feb. 14, 2023.

(51) Int. Cl. H01F 7/02; H02N 11/00

(52) U.S. Cl. CPC H01F 7/0273; H02N 11/006

(57) ABSTRACT

Aspects of the present disclosure provide movers and displacement systems which may have improved rotational control and performance. Such a displacement system may include a mover operable to move in response to an external magnetic field, and a plurality of electrical conductors arranged non-circularly and positioned to generate the external magnetic field. The mover may include an actuation magnet configured to generate forces for moving the mover in response to the external magnetic field and including a plurality of magnetization regions distributed rotationally around a reference point of the mover, each magnetization region including a respective magnetization direction. At least five nonoverlapping paths may intervene between respective different pairs of adjacent magnetization regions, the magnetization regions of each of the pairs including respective magnetization directions different from each other, each nonoverlapping path extending from the reference point to a periphery of the plurality of magnetization regions.

### CROSS-REFERENCE TO RELATED APPLICATION

This application claims the benefit of and priority from U.S. provisional patent application No. 63/445,582, filed Feb. 14, 2023, the entire contents of which are incorporated by reference herein.

### FIELD

This disclosure relates generally to displacement systems or conveyors and movers for such systems.

### BACKGROUND

Displacement systems, or conveyors, such as XY tables and rotary tables may be used in various manufacturing, inspection, and assembling processes. These systems may include a stator and a mover, typically referred to as a robotic device, mover device, or moveable stage. The stator actuates the mover. XY motion may be achieved by stacking two linear stages (e.g., a X-stage and a Y-stage) together via connecting bearings. Alternatively, a single moving stage capable of XY motion may be used, eliminating additional bearings. It may also be desirable for such a moving stage to be able to provide at least some Z motion.

Attempts have been made to design displacement systems using the interaction between current-carrying coils and permanent magnets. Examples include: U.S. Pat. Nos. 6,003,230; 6,097,114; 6,208,045; 6,441,514; 6,847,134; 6,987,335; 7,436,135;

7,948,122; US patent publication No. 2008/0203828; W. J. Kim and D. L. Trumper, High-precision magnetic levitation stage for photolithography. Precision Eng. 22 2 (1998), pp. 66-77; D. L. Trumper, et al, “Magnet arrays for synchronous machines”, IEEE Industry Applications Society Annual Meeting, vol. 1, pp. 9-18, 1993; and J. W. Jansen, C. M. M. van Lierop, E. A. Lomonova, A. J. A. Vandenput, “Magnetically Levitated Planar Actuator with Moving Magnets”, IEEE Tran. Ind. App., Vol 44, No 4, 2008.

More recent techniques for implementing displacement systems having a mover and a stator are described in: PCT application No. PCT/CA2012/050751 (published under WO/2013/059934) entitled DISPLACEMENT DEVICES AND METHODS FOR FABRICATION, USE AND CONTROL OF SAME; PCT application No. PCT/CA2014/050739 (published under WO/2015/017933) entitled DISPLACEMENT DEVICES AND METHODS AND APPARATUS FOR DETECTING AND ESTIMATING MOTION ASSOCIATED WITH SAME; PCT application No. PCT/CA2015/050549 (published under WO/2015/188281) entitled DISPLACEMENT DEVICES, MOVEABLE STAGES FOR DISPLACEMENT DEVICES AND METHODS FOR FABRICATION, USE AND CONTROL OF SAME; PCT application No. PCT/CA2015/050523 (published under WO/2015/184553) entitled METHODS AND SYSTEMS FOR CONTROLLABLY MOVING MULTIPLE MOVEABLE STAGES IN A DISPLACEMENT DEVICE; and PCT application No. PCT/CA2015/050157 (published under WO/2015/179962) entitled DISPLACEMENT DEVICES AND METHODS FOR FABRICATION, USE AND CONTROL OF SAME.

However, existing displacement systems may lack certain functionality and performance. For example, existing systems may have limited rotational control or performance at certain mover orientations and/or locations on a stator due to poor efficiency in generating actuating forces at those orientations and/or locations.

### SUMMARY

Embodiments of the present disclosure may provide movers and displacement systems having improved rotational control and performance.

According to at least one embodiment, there is disclosed a mover operable to move in response to at least one external magnetic field, the mover comprising: at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction, wherein: at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions; and at least a portion of at least one boundary region between adjacent magnetization regions of the plurality of magnetization regions intersects a straight line passing through the reference point and through at least one of the adjacent magnetization regions bounded by the at least one boundary region.

According to at least one embodiment, there is disclosed a displacement system comprising: a mover operable to move in response to at least one external magnetic field, the mover comprising: at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction, wherein at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions; and a plurality of electrical conductors arranged non-circularly and positioned to generate the at least one external magnetic field.

In some embodiments, the at least five nonoverlapping paths comprise at least twelve nonoverlapping paths intervening between respective different pairs of adjacent magnetization regions of the plurality of magnetization regions.

In some embodiments, the at least five nonoverlapping paths comprise at least sixteen nonoverlapping paths intervening between respective different pairs of adjacent magnetization regions of the plurality of magnetization regions.

In some embodiments, at least one of the at least five nonoverlapping paths is radially monotonic between the reference point and the periphery.

In some embodiments, at least a portion of at least one boundary region between adjacent magnetization regions of the plurality of magnetization regions intersects a straight line passing through the reference point and through at least one of the adjacent magnetization regions bounded by the at least one boundary region.

In some embodiments, adjacent magnetization regions of the plurality of magnetization regions comprise different magnetization directions.

In some embodiments, at least a portion of a centerline of at least one of the plurality of magnetization regions intersects a straight line passing through the reference point at a non-zero skew angle, the centerline extending along the at least one of the plurality of magnetization regions equidistantly between a pair of adjacent ones of the at least five nonoverlapping paths bounding the at least one of the plurality of magnetization regions.

In some embodiments, the plurality of magnetization regions is between a first cylindrical surface and a second cylindrical surface concentric with the first cylindrical surface, axes of the first and second cylindrical surfaces passing through the reference point; the first cylindrical surface has a first diameter; and the second cylindrical surface has a second diameter greater than the first diameter.

In some embodiments, the at least one actuation magnet comprises a plurality of actuation magnets.

In some embodiments, each of the plurality of magnetization regions contains at least one of the plurality of actuation magnets.

In some embodiments, the plurality of electrical conductors are arranged along a rectilinear spacing grid.

In some embodiments, the plurality of electrical conductors comprises: a first plurality of electrical conductors extending in a first direction, at least some of the first plurality of electrical conductors spaced apart from one another in a second direction nonparallel to the first direction; and a second plurality of electrical conductors extending in a third direction nonparallel to the first direction, at least some of the second plurality of electrical conductors spaced apart from one another in a fourth direction nonparallel to the third direction.

In some embodiments, the first, second, third, and fourth directions are generally in a common plane.

In some embodiments, at least some of the first plurality of conductors are spaced apart from one another in the first direction.

In some embodiments, at least some of the second plurality of conductors are spaced apart from one another in the third direction.

In some embodiments, each of the first plurality of electrical conductors has a fixed first conductor length in the first direction.

In some embodiments, the first diameter is greater than 80 percent of the first conductor length.

In some embodiments, each of the second plurality of electrical conductors has a fixed second conductor length in the third direction.

In some embodiments, the first diameter is greater than 80 percent of the second conductor length.

Other aspects and features will become apparent to those ordinarily skilled in the art upon review of the following description of illustrative embodiments in conjunction with the accompanying figures.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a front section view of a displacement system according to one embodiment.

FIG. 2 is a plan view of a displacement system according to another embodiment.

FIG. 3 is a plan view of the displacement system of FIG. 2, partially cut away to show magnetization regions of a mover of the displacement system of FIG. 2 and electrical conductors of a stator of the displacement system of FIG. 2.

FIG. 4 is a plan view of a displacement system according to another embodiment, partially cut away to show magnetization regions of a mover of the displacement system and electrical conductors of a stator of the displacement system.

FIG. 5 is a plan view of a displacement system according to another embodiment, partially cut away to show magnetization regions of a mover of the displacement system and electrical conductors of a stator of the displacement system.

FIG. 6 is a plan view of a mover usable with the displacement system of FIG. 1.

FIG. 7 is a plan view of a displacement system according to another embodiment, partially cut away to show magnetization regions of a mover of the displacement system and electrical conductors of a stator of the displacement system.

FIG. 8 is a plan view of an alternate mover usable with the displacement system of FIG. 7.

FIG. 9 is a plan view of another alternate mover usable with the displacement system of FIG. 7.

FIG. 10 is a plan view of another alternate mover usable with the displacement systems of FIGS. 1, 2, 3, 4, and/or 7.

FIG. 11 is a plan view of another alternate mover usable with the displacement systems of FIGS. 1, 2, 3, 4, and/or 7.

FIG. 12 is a plan view of another alternate mover usable with the displacement systems of FIGS. 1, 2, 3, 4, and/or 7.

FIG. 13 is a side section view of the mover of FIG. 12.

FIG. 14 is a plan view of a magnetization region array according to another embodiment.

FIG. 15 is a plan view of another magnetization region array according to another embodiment.

FIG. 16 is a plan view of another alternate mover usable with the displacement system of FIG. 7.

FIG. 17 is a plan view of another alternate mover usable with the displacement system of FIG. 7.

FIG. 18 is a plan view of another alternate mover usable with the displacement systems of FIGS. 1, 2, 3, 4, and/or 7.

FIG. 19 is a plan view of another alternate mover usable with the displacement systems of FIGS. 1, 2, 3, 4, and/or 7.

FIG. 20 is another plan view of the mover of FIG. 19, with annotations for magnetization direction removed for clarity.

FIG. 21 is a plan view of a mover usable with the displacement systems of FIGS. 1, 2, 3, 4, and/or 7, demonstrating an effect of introducing a skew angle to the mover.

FIG. 22 is a plan view of a mover usable with the displacement systems of FIGS. 1, 2, 3, 4, and/or 7, demonstrating an effect of using multiple skew angles with the mover.

FIG. 23 is a plan view of the mover of FIG. 19 demonstrating regions of the mover involved in force generation.

FIG. 24 is a plan view of a mover usable with the displacement systems of FIGS. 1, 2, 3, 4, and/or 7, accompanied by a graph of a magnetic field of the mover.

FIG. 25 is a plan view of the mover of FIG. 24 at a different rotational position, accompanied by a graph of a magnetic field of the mover at the different rotational position.

FIG. 26 is a plan view of the mover of FIG. 19, accompanied by a graph of a magnetic field of the mover.

FIG. 27 is a plan view of the mover of FIG. 26 at a different rotational position, accompanied by a graph of a magnetic field of the mover at the different rotational position.

FIG. 28 is a plan view of another alternate mover usable with the displacement systems of FIGS. 1, 2, 3, 4, and/or 7.

FIG. 29 is a plan view of another alternate mover usable with the displacement systems of FIGS. 1, 2, 3, 4, and/or 7.

FIG. 30 is a plan view of another alternate mover usable with the displacement systems of FIGS. 1, 2, 3, 4, and/or 7.

FIG. 31 is a schematic showing a control system usable with the displacement systems of FIGS. 1, 2, 3, 4, and/or 7.

### DETAILED DESCRIPTION

Manufacturing, assembly, and inspection systems may use displacement systems, or conveyors, to transport components to be processed, combined, and packaged.

Electromagnetic planar motors may be used as displacement systems in such applications. An electromagnetic planar motor generally includes one or more movers for holding components and one or more stators for supporting and driving/actuating the movers. Movers having rotationally distributed magnetization regions are described herein, along with displacement systems for using such movers.

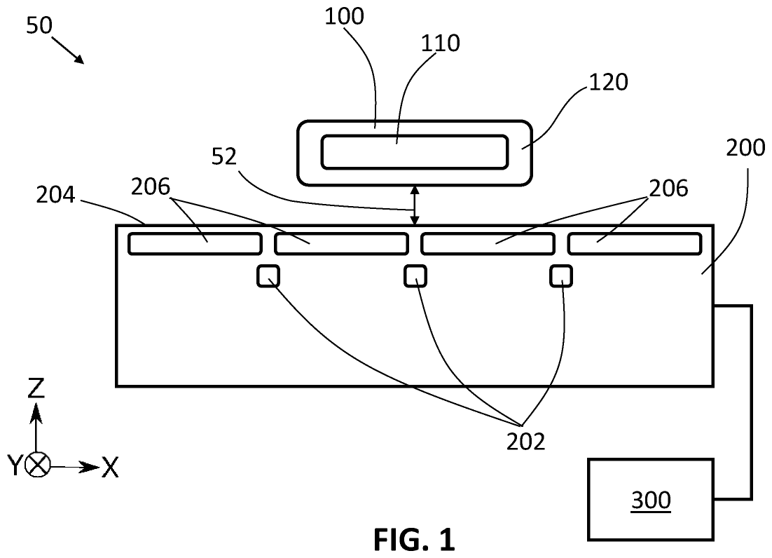

Referring to FIG. 1, a displacement system according to one embodiment is shown generally at 50 and includes a mover 100, a stator 200, and a controller 300. The mover 100 may be configured to carry one or more components (not shown). The mover 100 may also be referred to as a “mover device”, a “robotic device”, a “moveable stage”, a “motion stage”, or a “moveable motion stage”. Further, as used herein, the term “component” is a general term and non-limiting examples of components that may be carried by the mover 100 may include workpieces, products being assembled, raw parts, materials, samples, biological samples, drugs, payloads, devices, and assemblies. In the embodiment shown, the displacement system 50 includes only one mover 100. However, alternative embodiments may include multiple movers, and in some alternative embodiments, a plurality of movers may carry a holder which may hold one or more components. In some systems, all movers are substantially similar or nearly identical. However, other systems may include movers of varying sizes and configurations.

The stator 200 supports and actuates the mover 100, such that the mover 100 travels across the stator 200 to another location in displacement system 50. In the embodiment shown, the displacement system 50 includes only one stator 200. However, alternative embodiments may include multiple stators, and in some alternative embodiments, the multiple stators may be of different types-for example, in some alternative embodiments, some stators may have large work areas, while other stators may function as flyways between the work areas for rapid movement of movers and components in narrow spaces. This may be achieved by arranging a stator made from multiple electromagnetic driving regions, arranged in a single row in the direction of movement of the mover.

The controller 300 controls the stator 200 and the mover 100. The controller 300 may be directly connected to the stator 200 using a wired or wireless connection, and may control the mover 100 indirectly through the stator 200. Alternatively, the controller 300 may also be connected to the mover 100 using a wired or wireless connection, such that the controller 300 may communicate with the mover 100 directly. For example, a high speed data cable may be used, such as an ethernet cable, a HDMI cable, or any cable of sufficient data rate bandwidth. In some embodiments, the controller 300 may be completely integrated with the stator 200. In embodiments where the controller 300 is completely integrated within the stator 200, any method of electrical connection may be used, such as ribbon cables, edge board connectors, wire connectors, headers and pins, etc. A wireless connection may include Bluetooth, WiFi, Zigbee, Cellular, NFC, etc. In some embodiments, more than one controller may be used within the displacement system 50. For example, the controller 300 may only control the stator 200 or a group of stators including the stator 200, while another controller may control another stator or group of stators.

Generally, the mover 100 and the stator 200 may interact with each other via one or more magnetic fields, so that the stator 200 can provide forces and torques to the mover 100 to controllably move the mover 100. The controller 300 may determine and provide commands to the stator 200 to generate specific forces and torques to move the mover 100.

A pair of coordinate systems may be defined to help explain the movement of the mover 100 relative to the stator 200. In particular, a stator coordinate system may be defined, which is fixed to the stator 200. A mover coordinate system may also be defined, which is fixed to the mover 100 and moves with the mover 100 relative to the stator 200 and the stator coordinate system. Conventional Cartesian coordinates (x, y, z) may be used to describe these coordinate systems, although it will be appreciated that other coordinate systems could be used. For convenience and brevity, in the present description and the associated drawings, the directions (e.g., x, y, z directions) in the stator coordinate system and the directions in the mover coordinate system may be shown and described as being coincident with one another i.e., the stator-x (or Xs), stator-y (or Ys), and stator-z (or Zs) directions may be shown as coincident with mover-x (or Xm), mover-y (Ym), and mover-z (or Zm) directions, respectively. Accordingly, reference to directions x, y, and/or z may refer to directions in both or either of the stator and mover coordinate systems. However, it will be appreciated from the context herein that in some embodiments and/or circumstances, the mover 100 may move relative to the stator 200 such that these stator and mover coordinate systems are no longer coincident with one another. In such cases, the following convention may be adopted: the terms stator-x, stator-y and stator-z may be used to refer to directions and/or coordinates in the stator coordinate system and the terms mover-x, mover-y and mover-z may be used to refer to directions and/or coordinates in the mover coordinate system. The symbols Xm, Ym, and Zm may be used to refer respectively to the mover-x, mover-y and mover-z directions, the symbols Xs, Ys, and Zs may be used to refer respectively to the stator-x, stator-y and stator-z directions and the symbols X, Y, and Z may be used to refer respectively to either or both of the mover-x, mover-y, and mover-z and/or stator-x, stator-y, and stator-z directions. In some embodiments, during normal operation, the mover-z and stator-z directions are approximately in the same direction (e.g. within ±30° in some embodiments; within ±10° in some embodiments; and within ±2° in some embodiments).

The mover 100 includes a structural frame 120 and one or more actuation magnets 110 fixed to the structural frame 120. The structural frame 120 may be used to provide support to the magnets, facilitate bonding, and/or provide an interface for a part, fixture, or tooling. In some embodiments, the structural frame 120 may optionally be used to mount additional mounting or locating features (not shown). The one or more actuation magnets 110 may also be referred to as an “actuation magnet assembly” or, more generally, a “magnet assembly”. The one or more actuation magnets 110 may be, for example, permanent magnets. In some embodiments, the one or more actuation magnet 110 may include a plurality of magnetization regions, each magnetization region having a respective magnetization direction. In FIG. 1, the mover 100 is shown as including a single actuation magnet 110. However, in some embodiments, the mover 100 may include more than one actuation magnet 110, that is, the mover 100 may include a plurality of actuation magnets 110. In such embodiments, one, some, or all of the plurality of actuation magnets 110 may be fixed to the structural frame 120. The one or more actuation magnets 110 are configured to respond to one or more external magnetic fields, and in particular are configured to generate forces for moving the mover 100 in response to one or more external magnetic fields. Examples of such actuation magnets are described and illustrated in U.S. Pat. No. 10,222,237 (incorporated herein by reference) as arrays of permanent magnets 112A, 112B, 112C, 112D (or collectively, magnet arrays 112).

Still referring to FIG. 1, the stator 200 includes sensors 202 and electrical conductors 206. Each of the sensors 202 is configured to measure at least one magnetic field. Each of the sensors 202 may only accurately measure a magnetic field within a certain range of that sensor 202. Examples of such sensors are described and illustrated in U.S. Pat. No. 10,222,237 as magnetic field sensors 501. The sensors 202 may include, for example, Hall-effect magnetic field sensors, magneto-resistive sensors, and/or other suitable types of magnetic field sensors that can measure magnetic flux density. In FIG. 1, the stator 200 is shown as including three sensors 202; however, it will be appreciated that in some embodiments, the stator 200 may include only one sensor 202, or two sensors 202, or more than three sensors 202. These sensors 202 may also be arranged at positions extending along the Y direction in addition to different X positions that are shown in FIG. 1.

Each of the electrical conductors 206 is configured to generate at least one external magnetic field. The electrical conductors 206 may be, for example, coils. Examples of such coils are described and illustrated in U.S. Pat. No. 10,222,237 as coil traces 126. In FIG. 1, the stator 200 is shown as including four electrical conductors 206; however, it will be appreciated that in some embodiments, the stator 200 may include only one electrical conductor 206, two electrical conductors 206, three electrical conductors 206, or more than four electrical conductors 206. In some embodiments, the stator 200 may include a plurality of electrical conductors distributed in one or more planar layers. In some embodiments, the layout of the electrical conductors 206 may include a first group of coils that are linearly oriented and/or elongated in a first direction (e.g., the X-direction as shown in FIG. 1). The first group of coils may also include a second coil pitch or spacing in a second direction (e.g., the Y-direction as shown in FIG. 1). The electrical conductors 206 may also include a second group of coils that are linearly elongated in the second direction. The second group of coils may also include a first coil pitch or spacing in the first direction. The first and second coil pitch/spacing may be equal. In some embodiments, the electrical conductors 206 may be linearly elongated in different directions (e.g., linearly elongated in the X-direction or linearly elongated in the Y-direction) and may vertically overlap with other electrical conductors.

The sensors 202 and electrical conductors 206 may be arranged in a pattern on the stator 200, for example as described and illustrated in U.S. Pat. No. 10,222,237. Patterns may include one or more sensors 202 configured around each of the electrical conductors 206, such as one of the sensors 202 at each edge of one of the electrical conductors 206. Other patterns may also be possible. It will be appreciated that the sensors 202 may be arranged in patterns near or around the electrical conductors 206 to provide proper feedback to the controller 300 for position sensing and control of the mover 100, for example. In some embodiments, the stator 200 may further include a plurality of iron teeth (not shown).

The stator 200 includes a working surface 204 for the mover 100 to move upon. Generally, the working surface 204 describes a continuous area upon which the mover 100 may be controlled by the stator 200. Suitable feedback control algorithms executed by the controller 300 and suitable position feedback from the sensors 202 allow the controller 300 and the stator 200 to move and control the mover 100. The working surface 204 may be flat, curved, cylindrical, spherical or some other shape that allows the mover 100 to move along the working surface 204. In some embodiments, a combined working surface may be defined by a plurality of stators, such that each working surface of each stator may be combined into a larger combined working surface. While the working surface 204 is depicted horizontally in FIG. 1, it should be understood that the working surface 204 can be mounted vertically or at an angle to gravity.

The mover 100 may move along the working surface 204 in a “contact mode” or a “non-contact mode”. The contact mode (also known as “sitting mode”) may involve contact media such as sliding and/or rolling bearings. The non-contact mode (also known as “levitation mode”) may require maintaining a controllable gap 52 between the mover 100 and the working surface 204 of the stator 200 in a normal direction Z. The gap 52 may be an air gap. The mover 100 may also rest upon the working surface 204 without moving, which may be in a contact mode or a non-contact mode. In the non-contact mode, the mover 100 may have six degrees-of-freedom (6-DOF) controllable motion (known as “active levitation mode”). Alternatively, the mover 100 may maintain the gap 52 by passive levitation means (known as “passive levitation mode”). In the passive levitation mode, the mover 100 may rest above the working surface 204 in the non-contact mode.

In some embodiments described herein, one or more amplifiers (not shown) may be connected to the electrical conductors 206. The amplifiers may drive one or more electrical currents in the electrical conductors 206, generating one or more external magnetic fields. The controller 300 may be connected to deliver control signals to the one or more amplifiers. The control signals may be used to control current driven by the one or more amplifiers into the electrical conductors 206. The current controllably driven into each of the electrical conductors 206 may cause that electrical conductors 206 to create or generate at least one external magnetic field. The at least one external magnetic field thus generated causes corresponding magnetic forces to act on the mover 100. The one or more external magnetic fields may act on the actuation magnet 110, thereby moving the mover 100 relative to the stator 200, such as across the working surface 204. The mover 100 may be controllable in at least two degrees-of-freedom (2-DOF) motions, including but not limited to three in-plane degrees-of-freedom (3-DOF) controllable motions and 6-DOF controllable motions.

In some embodiments, the magnetic forces associated with the interactions between the magnetic fields created by the currents in the electrical conductors 206 and the magnetic fields associated with the actuation magnet 110 may attract the mover 100 toward the stator 200 at all times when a controller is controlling the currents driven by one or more amplifiers. In other embodiments, the magnetic forces associated with the interactions between the magnetic fields created by the currents in the electrical conductors 206 and the magnetic fields associated with the actuation magnet 110 may force the mover 100 away from the stator 200 to balance gravitational forces with the gap 52 at all times.

In some embodiments, the gap 52 between the mover 100 and the stator 200 may be maintained by air bearings or compressed-fluid bearings. It will be appreciated that in some embodiments, the gap 52 may be zero, such as when the mover 100 operates in contact mode. Contact mode may involve contact media such as sliding and/or rolling bearings between mover device 100 and working surface 204.

As described above, the mover 100 may work in “levitation mode”, being levitated near the working surface 204 of the stator 200 without contacting the stator 200. In levitation mode, the mover 100 may move along the stator 200 working surface 204 in X and Y directions, where X and Y are two non-parallel (e.g., orthogonal) directions inside the working surface 204. It will be appreciated that the gap 52 between the working surface 204 and a bottom surface of the mover 100 is generally much smaller than the mover's lateral dimensions (i.e., dimensions in the X and Y directions).

Although the mover 100 may be capable of 6-DOF controllable motion, such functionality may not be necessary in all situations. In certain embodiments, levitation of the mover 100 may not be needed and heavy load carrying capability of the mover 100 may be desirable. In such embodiments, the mover 100 may sit on the working surface 204 supported with mechanical bearings (for example, planar sliding bearings and/or ball transfer units), and may be capable of in-plane 3-DOF controllable motion: translation in X and Y and rotation around Z, where X and Y are two non-parallel (e.g., orthogonal) directions in working surface 204 and Z is a direction normal to the working surface 204. When the mover 100 relies on sliding and/or rolling bearings for support on the working surface 204 and the mover 100 is capable of 3-DOF controllable motion, it may be referred to as working in “3-DOF controlled sitting mode”.

In some embodiments, the mover 100 may be capable of in-plane 3-DOF controllable motions (translations in X and Y and rotation around Z) working in levitation mode without contact with working surface 204. In this mode, the translation in Z, rotation around X, and rotation around Y (and thus the associated degrees-of-freedom) of the mover 100 may be open-loop controlled without feedback, using suitable passive levitation technology. When the mover 100 is capable of 3-DOF controllable motion without contact with the stator 200, it may be referred to as working in “3-DOF controlled levitation mode”.

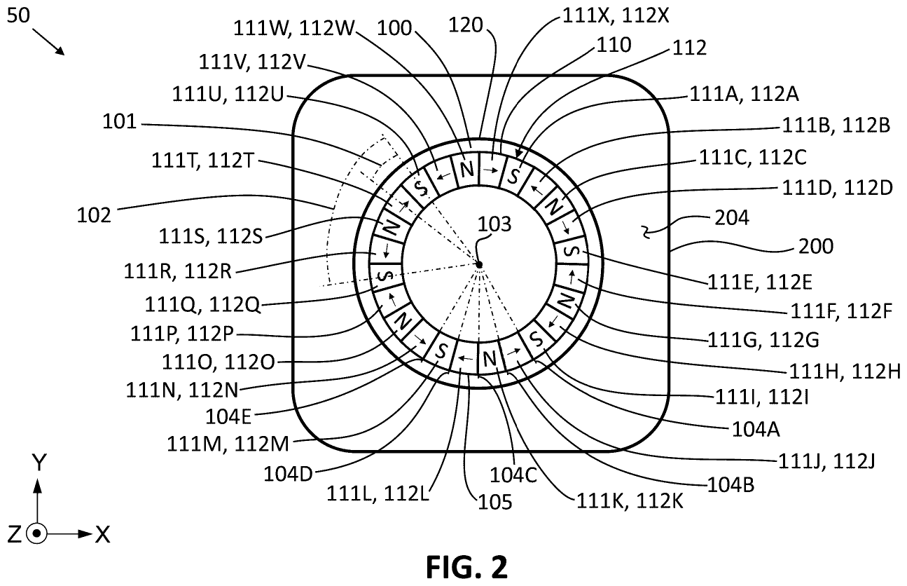

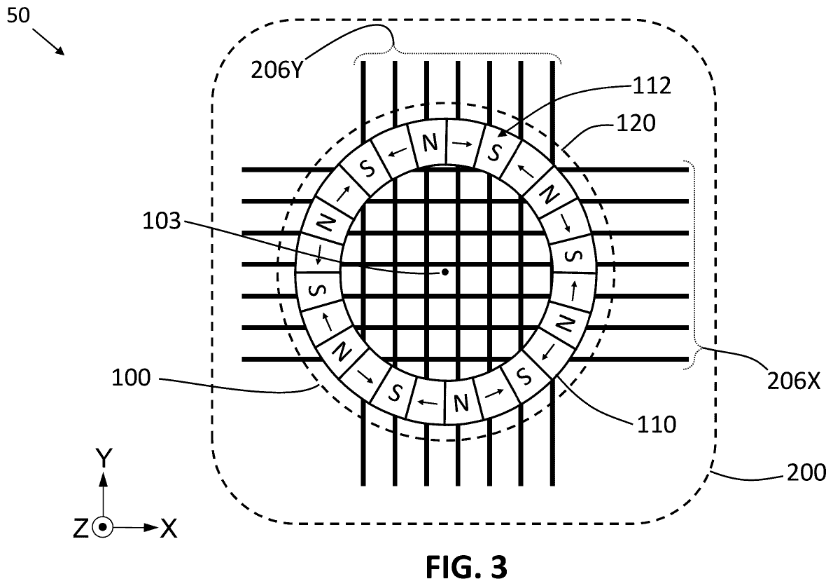

Referring to FIGS. 2 and 3, a particular non-limiting embodiment of the displacement system 50 of FIG. 1 is shown, and, as described above, includes the mover 100 and the stator 200. In the embodiment shown in FIGS. 2 and 3, the mover 100 includes an actuation magnet assembly 110 made up of a plurality of smaller actuation magnets 111 fixed or mounted to a frame 120. More specifically, the actuation magnet assembly 110 includes actuation magnets 111A, 111B, 111C, 111D, 111E, 111F, 111G, 111H, 111I, 111J, 111K, 111L, 111M, 111N, 111O, 111P, 111Q, 111R, 111S, 111T, 111U, 111V, 111W, and 111X. The actuation magnet assembly 110 also includes a plurality of magnetization regions 112. More specifically, the actuation magnet assembly 110 includes magnetization regions 112A, 112B, 112C, 112D, 112E, 112F, 112G, 112H, 1121, 112J, 112K, 112L, 112M, 112N, 112O, 112P, 112Q, 112R, 112S, 112T, 112U, 112V, 112W, and 112X. Each of the plurality of magnetization regions 112 includes a respective magnetization direction. For example, the magnetization region 112A has a magnetization direction with the North direction oriented out of the page (i.e., along the positive Z-direction), while the magnetization region 112B has a magnetization direction with the North direction oriented within the plane of the page (i.e., within the X-Y plane), and the magnetization region 112C has a magnetization direction with the North direction oriented into the page (i.e., along the negative Z-direction) and thus the South direction oriented out of the page. Generally, in the embodiment shown, adjacent magnetization regions have different respective magnetization directions. However, in alternative embodiments, some adjacent magnetization regions may have the same respective magnetization directions.

In the embodiment shown in FIGS. 2 and 3, each of the magnetization regions 112 corresponds to a respective one of the plurality of actuation magnets 111. That is, each of the magnetization regions 112 contains a respective one of the plurality of actuation magnets 111. For example, the magnetization region 112A contains the actuation magnet 111A, the magnetization region 112B contains the actuation magnet 111B, and the magnetization region 112C contains the actuation magnet 111C. However, alternative embodiments may vary. For example, in some alternative embodiments, a single magnetization region may contain a plurality of the plurality of actuation magnets 111. Similarly, in some alternative embodiments, each magnetization region of the plurality of magnetization regions 112 may contain a plurality of the plurality of actuation magnets 111. That is, it will be appreciated that although each of the actuation magnets 111 is shown in FIGS. 2 and 3 as a single part, the same magnetic effect can be achieved with multiple smaller magnetic pieces joined together to form the same shape, which may be done to simplify manufacturing. Similarly, it will also be appreciated that multiple actuation magnets 111 with differing magnetization may instead be manufactured as a single multi-pole magnet, which may be done to simplify assembly.

The plurality of magnetization regions 112 (and thus the plurality of actuation magnets 111) is distributed rotationally around a reference point 103 of the mover 100. More specifically, in the embodiment shown, the magnetization regions 112 are arranged in a circumferential pattern forming a ring or toroid shape around the reference point 103, with circumferentially adjacent magnetization regions separated by a fixed angular pitch 101 relative to the reference point 103. That is, the angular pitch 101 is the angle between adjacent magnetization regions relative to the reference point 103. In the arrangement of the embodiment shown, multiple nonoverlapping (i.e., unique) paths extend from the reference point 103 to a periphery 105 of the plurality of magnetization regions 112 by intervening between respective different pairs of adjacent magnetization regions of the plurality of magnetization regions 112, the magnetization regions of each of the pairs of adjacent magnetization regions having respective magnetization directions different from each other. That is, the paths are nonoverlapping in that no two paths intervene between the same pair of adjacent magnetization regions. For example, path 104A extends from the reference point 103 to the periphery 105 by intervening between the magnetization region 112I and the magnetization region 112J, and the magnetization region 112I and 112J have different magnetization directions. Similarly, path 104B extends from the reference point 103 to the periphery 105 by intervening between the magnetization region 112J and the magnetization region 112K; path 104C extends from the reference point 103 to the periphery 105 by intervening between the magnetization region 112K and the magnetization region 112L; path 104D extends from the reference point 103 to the periphery 105 by intervening between the magnetization region 112L and the magnetization region 112M; and path 104E extends from the reference point 103 to the periphery 105 by intervening between the magnetization region 112M and the magnetization region 112N. In the embodiment shown, each of these nonoverlapping paths is radially monotonic between the reference point 103 and the periphery 105. That is, each path extends radially outwardly along its entire length. Overall, in the embodiment shown in FIGS. 2 and 3, twenty-four such nonoverlapping paths extend from the reference point 103 to the periphery 105 by intervening between respective different pairs of adjacent magnetization regions having different magnetization directions. However, alternative embodiments may differ. For example, in some alternative embodiments, there may be five nonoverlapping paths extending from the reference point 103 to the periphery 105 by intervening between respective different pairs of adjacent magnetization regions having different magnetization directions. In other alternative embodiments, there may be, for example, six, seven, eight, nine, ten, twelve, sixteen, or twenty such nonoverlapping paths. Additionally, in the embodiment shown, the nonoverlapping paths may be considered to be in a common plane (i.e., the X-Y plane). However, in alternative embodiments, such nonoverlapping paths may not be in a common plane.

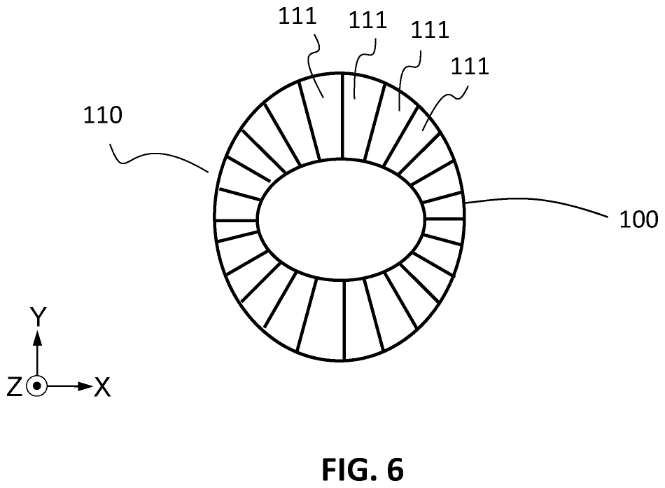

The periphery 105 of the plurality of magnetization regions 112 may be defined, for example, by a convex hull of the plurality of magnetization regions 112. In the embodiment shown, the periphery 105 is substantially circular in the X-Y plane. However, alternative embodiments may differ. For example, in some alternative embodiments, the periphery 105 may be substantially elliptical in the X-Y plane (see, e.g., FIG. 6), while in other alternative embodiments, the periphery 105 may not be circular or elliptical but may be curved.

As noted above, in the embodiment shown in FIGS. 2 and 3, adjacent magnetization regions of the plurality of magnetization regions 112 have different respective magnetization directions. More specifically, the magnetization regions 112 of the embodiment shown are arranged by magnetization direction in a repeating circumferential pattern. That is, along a circumferential repetition path within the X-Y plane at a fixed distance from the reference point 103 which passes through each of the plurality of magnetization regions 112, adjacent magnetization regions have sequentially different respective magnetization directions in a repeating pattern. Neighbouring magnetization regions having the same magnetization direction are separated by a fixed angular period 102 relative to the reference point 103. (It will be appreciated that although angular period 102 is shown in FIG. 2 as being between two magnetization regions having magnetization directions with the North direction oriented out of the page, the angular period 102 can equivalently be defined as being between any neighbouring pair of magnetization regions with the same relative magnetization). In the embodiment shown, the repeating pattern of the plurality of magnetization regions 112 generally forms a circular Halbach array.

Still referring to FIGS. 2 and 3, the stator 200 includes a plurality of electrical conductors 206 arranged non-circularly and positioned to generate an external magnetic field to actuate the mover 100 to move in up to 6 DOFs, including rotation. In the embodiment shown, the plurality of electrical conductors 206 includes a plurality of electrical conductors 206X oriented in the X-direction and a plurality of electrical conductors 206Y oriented in the Y-direction. The plurality of electrical conductors 206X extend in the X-direction, and are generally spaced apart in the Y-direction at a fixed Y-direction spacing. Similarly, the plurality of electrical conductors 206Y extend in the Y-direction, and are generally spaced apart in the X-direction at a fixed X-direction spacing. In the embodiment shown, the fixed Y-direction spacing of the electrical conductors 206X is substantially equal to the fixed X-direction spacing of the electrical conductors 206Y. Therefore, in the embodiment shown in FIG. 3, the plurality of electrical conductors 206 is generally arranged along a two-dimensional Cartesian spacing grid. However, in alternative embodiments, the electrical conductors 206 may instead be arranged along a different type of spacing grid, such as a different rectilinear spacing grid, a rhomboidal spacing grid, or a triangular spacing grid.

When the electrical conductors 206 cause the mover 100 to rotate within the X-Y plane about an axis in the Z-direction (i.e., to Rz rotational motion), the repeating circumferential pattern of the magnetization regions 112 of the actuation magnet assembly 110 may be used to generate uniform actuating forces as the mover is rotated to different Rz rotational positions. This arrangement of magnetization regions can result in improved performance over linear magnet arrangements during a full range of rotation about an axis in the Z-direction.

Although in the embodiment shown in FIG. 3, the X-oriented plurality of electrical conductors 206X and the Y-oriented conductors plurality of 206Y are continuous, it should be understood that in alternative embodiments, individual electrical conductors of the pluralities of electrical conductors 206X and 206Y may be sub-divided into elements that may be independently controllable. Thus, for example, in some embodiments, the X-oriented plurality of electrical conductors 206X may effectively include electrical conductors that are spaced apart in the X-direction (in addition to being spaced apart in the Y-direction). Similarly, in some embodiments, the Y-oriented plurality of electrical conductors 206Y may effectively include electrical conductors that are spaced apart in the Y-direction (in addition to being spaced apart in the X-direction). In some embodiments, X-direction spacing of the X-oriented plurality of electrical conductors 206X may be substantially equal to Y-direction spacing of the Y-oriented plurality of electrical conductors 206Y. In cases where the electrical conductors are sub-divided along X or Y in this way, it is possible to generate external magnetic field to separately control opposing sides of the plurality of magnetization regions 112 of the actuation magnet assembly 110, and thus of the mover 100, by controlling the respective subset of electrical conductors which overlap with each side. In positions where both the +X and −X sides of the mover 100 are each being controlled by independent sets of X-oriented conductors 206X, and the +Y and −Y sides of the magnet assembly are each being controlled by independent sets of Y-oriented conductors 206Y, control coupling between two different sides of the mover 100 can be kept to a minimum during Rz motion of the mover 100. In some embodiments, the X-oriented plurality of electrical conductors 206X may be shorter than a mean diameter of the plurality of magnetization regions 112, such that a sector of conductors can exclusively control only the +X or −X side of the mover 100 (with a minimum or no overlap of the opposing side) for a full range of possible X-positions. Similarly, in some embodiments, the Y-oriented plurality of electrical conductors 206Y may be shorter than the mean diameter of the plurality of magnetization regions 112, such that a sector of conductors can exclusively control only the +Y or −Y side of the mover 100 (with a minimum or no overlap of the opposing side) for a full range of possible Y-positions.

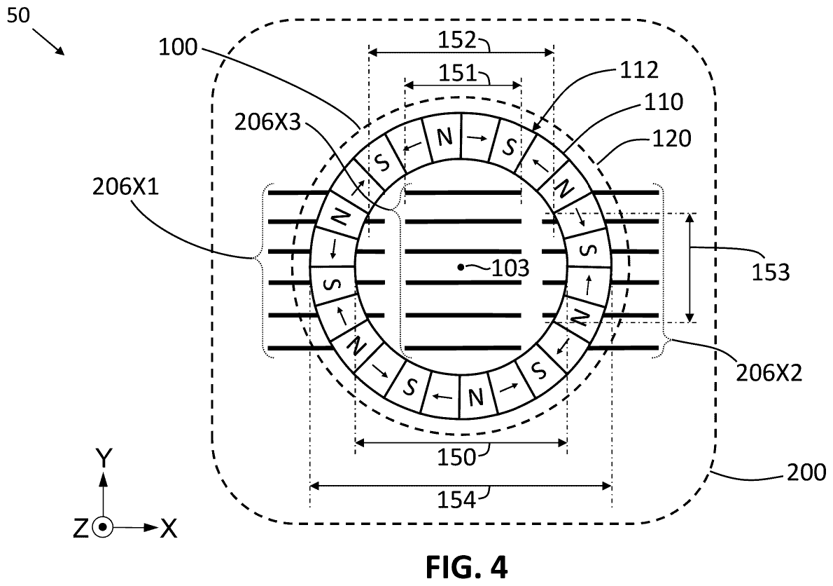

Referring now to FIG. 4, another non-limiting embodiment of the displacement system 50 of FIG. 1 is shown, and, as described above, includes the mover 100 and the stator 200. The embodiment of FIG. 4 is similar to that of FIGS. 2 and 3, except that in the stator 200 of the embodiment of FIG. 4, X-oriented conductors of the plurality of electrical conductors 206X have been sub-divided into conductor elements 206X1, 206X2, and 206X3. For clarity, the Y-oriented plurality of electrical conductors 206Y is not shown in FIG. 4. Each of the X-oriented conductor elements 206X1, 206X2, and 206X3 has a fixed conductor element length 151 in the X-direction. As in the embodiment of FIGS. 2 and 3, the mover 100 of FIG. 4 includes a plurality of magnetization regions 112 forming a ring or toroid shape around the reference point 103. As shown in FIG. 4, this ring/toroid of the plurality of magnetization regions 112 has an inner diameter 150 and an outer diameter 154. Thus, the plurality of magnetization regions 112 (and, correspondingly, the actuation magnet assembly 110) may be considered to be effectively located between—and radially bounded by—a pair of concentric cylindrical surfaces having axes passing through the reference point 103: an inner cylindrical surface with the inner diameter 150, and an outer cylindrical surface with the outer diameter 154. Based on the dimensions and relative positions of the plurality of electrical conductors 206 and the plurality of magnetization regions 112, it is also possible to define a utilized magnetic width 153 and a minimum chord length 152. The utilized magnetic width 153 is defined as the total range or width of electrical conductors 206 used to interact with and control one side of the plurality of magnetization regions 112. The minimum chord length 152 is geometrically defined using the Pythagorean Theorem: specifically, it is obtained from L=\sqrt{D²−W²}, where L is the minimum chord length 152, D is the inner diameter 150 of the plurality of magnetization regions 112, and W is the utilized magnet width 153.

The subdivision of X-oriented conductors of the plurality of electrical conductors 206X allows the conductor elements 206X1 and 206X2 to control the −X side and +X side of the mover 100, respectively, independently from one another. For such independent control to be possible at all X-positions of the mover 100, the conductor element length 151 should generally be less than the minimum chord length 152. However, partially independent control may also be possible if the conductor element length 151 is less than the inner diameter 150 of the plurality of magnetization regions 112, or if the conductor element length 151 is less than the outer diameter 154 of the plurality of magnetization regions 112. That is, such control may be possible if the inner diameter 150, or at least the outer diameter 154, is greater than the conductor element length 151. For example, in some embodiments, the inner diameter 150 may be greater than 80 percent of the conductor element length 151, or may be greater than 90 percent of the conductor element length 151. It will also be appreciated that by symmetry, similar constraints may be developed on how finely Y-oriented conductors of the plurality of electrical conductors 206Y may be divided to allow the −Y and +Y side of the mover 100 to be independently controlled at all Y-positions of the mover 100.

In some embodiments, the conductor element length 151 is constrained by the design of the stator 200. In these embodiments, such constraints on the conductor element length 151 can be reformulated as minimum size constraints on the plurality of magnetization regions 112 of the actuation magnet assembly 110.

In many cases, for a specific value of the inner diameter 150 of the plurality of magnetization regions 112, increasing the outer diameter 154 of the plurality of magnetization regions 112 will increase the overall amount of the actuation magnet 110 in the mover 100. However, it will also result in an increased variation between an inner portion of the plurality of magnetization regions 112 and an outer portion of the plurality of magnetization regions 112. For a given set of conductor elements 206X1 and 206X2 operating in conjunction to generate force on a particular side of the mover 100, it may be desirable for a large portion of the magnet area being used to generate the force to have a magnetic pitch/spacing in a direction of conductor distribution/spacing (typically orthogonal to a direction of conductor extension) that corresponds to the conductor spacing. For a toroidal arrangement of magnetization regions such as the plurality of magnetization regions 112 in the embodiments of FIGS. 2, 3, and 4, the magnetic pitch is effectively defined by the angular pitch 102. However, due to the tapered shape of the magnetization regions for such embodiments, it is expected that the magnetic pitch orthogonal to the radial direction would be greater at the outer portion of the plurality of magnetization regions 112, and lesser at the inner portion of the plurality of magnetization regions 112, where the magnetic pitch increases with distance from a center of the plurality of magnetization regions 112—i.e., from the reference point 103. Therefore, to achieve a particular nominal/average magnetic pitch in the plurality of magnetization regions 112 orthogonal to the radial direction, the outer diameter 154 and inner diameter 150 may be selected such that the inner portion of the plurality of magnetization regions 112 has a magnetic pitch less than desired, and the outer portion of the plurality of magnetization regions 112 has a magnetic pitch greater than desired, such that the desired magnetic pitch occurs close to a radial center of the effective magnet area that will be used for force generation by the conductors 206 for that particular region.

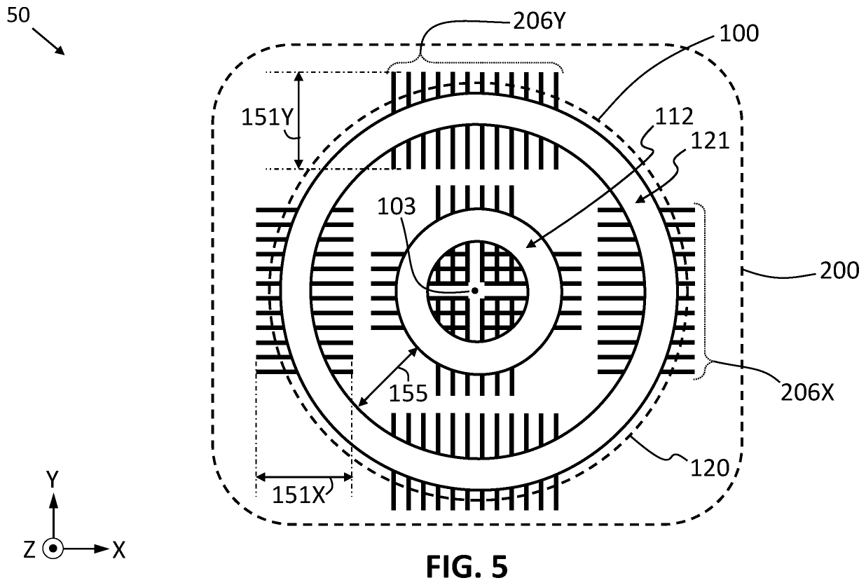

Referring now to FIG. 5, another non-limiting embodiment of the displacement system 50 of FIG. 1 is shown, and, as described above, includes the mover 100 and the stator 200. In the embodiment of FIG. 5, the mover 100 includes multiple pluralities of magnetization regions joined by the frame 120. More specifically, the mover includes an inner primary plurality of magnetization regions 112, which may be similar to the plurality of magnetization regions 112 of the embodiments of FIGS. 2, 3, and 4, and an outer secondary plurality of magnetization regions 121, which may be similar to the primary plurality of magnetization regions 112, but larger. Each of the primary plurality of magnetization regions 112 and the secondary plurality of magnetization regions 121 is generally rotationally distributed around the reference point 103, and each forms a ring or toroid shape. As they are both distributed around the reference point 103, the primary plurality of magnetization regions 112 is coaxial with the secondary plurality of magnetization regions 121. Additionally, the primary plurality of magnetization regions 112 is radially spaced apart from the secondary plurality of magnetization regions 121 by an inter-ring spacing 155. The use of multiple concentric rings/toroids may allow the mover 100 to have a higher payload capacity. Although the embodiment shown includes two rings/toroids of magnetization regions, alternative embodiments may include more than two such rings/toroids, to further increase payload capacity. It will also be appreciated that the two pluralities of magnetization regions 112 and 121 may have different angular pitches 101 and angular periods 102 (not shown).

The stator 200 of the embodiment of FIG. 5 includes a plurality of X-oriented electrical conductors 206X and a plurality of Y-oriented electrical conductors 206Y. X-oriented electrical conductors of the plurality of electrical conductors 206X have a conductor element length 151X, and Y-oriented electrical conductors of the plurality of electrical conductors 206Y have a conductor element length 151Y. However, for clarity, only electrical conductors which can apply significant force on the mover 100 are shown in FIG. 5. In general, a greater number of electrical conductors may apply force on the outer secondary plurality of magnetization regions 121 than on the inner primary plurality of magnetization regions 112, due to the larger size of the secondary plurality of magnetization regions 121.

It will be appreciated that because the primary and secondary pluralities of magnetization regions 112 and 121 may have different angular pitches 101, it may generally be desirable to be able to control the primary plurality of magnetization regions 112 independently from the secondary plurality of magnetization regions 121, so that forces may be efficiently generated on the mover 100 at all Rz rotational positions. Independent control of the primary and secondary pluralities of magnetization regions 112 and 121 may be achieved by designing the inter-ring spacing 155 to be larger than the conductor element lengths 151X and 151Y. Partially independent control of magnet assemblies 112A and 112B may be achieved by designing the inter-ring spacing 155 to be not significantly smaller than the conductor element lengths 151X and 151Y. For example, some embodiments, the inter-ring spacing 155 may be greater than 50% of the smaller of the conductor element lengths 151X and 151Y.

In some embodiments, the specific angular pitches 101 of the primary and secondary pluralities of magnetization regions 112 and 121, their relative orientations, and the inter-ring spacing 155 may be chosen to facilitate combined force generation where the inter-ring spacing 155 is less than the conductor element length 151X/151Y. To facilitate the force generation in this way, a number of magnetization regions in the secondary plurality of magnetization regions 121 may be chosen to be an integer multiple of a number of magnetization regions in the primary plurality of magnetization regions 112. The inter-ring spacing 155 may be chosen such that a magnetic pitch extending along a straight line orthogonal to the radial direction is similar for each of the primary and secondary pluralities of magnetization regions 112 and 121. Additionally, at least one of the magnetization regions in the primary plurality of magnetization regions 112 with a particular magnet orientation (e.g., North direction facing out of page) may be aligned with a magnetization region in the secondary plurality of magnetization regions 121 with the same magnetic orientation. A correct angular spacing, inter-ring spacing 155, and alignment between rings may enable electrical conductors overlapping with both the primary and secondary pluralities of magnetization regions 112 and 121 to generate forces on both pluralities of magnetization regions constructively.

FIG. 6 depicts a non-limiting embodiment of the mover 100 of the displacement system 50 of FIG. 1. The mover 100 of this embodiment includes an actuation magnet assembly 110 including a plurality of non-uniform smaller actuation magnets 111. Such an embodiment may allow for better performance in motion in some directions, but at the cost of worse performance in motion in other directions. For example, in the embodiment shown, because there are longer actuation magnets 111 that are aligned with the Y-axis, higher forces can be generated in the X-direction, and relatively lower forces can be generated in the Y-direction; thus, this embodiment may have better performance in the X-direction than in the Y-direction.

Although in the embodiments shown in FIGS. 2, 3, 4, and 6 the magnetization regions 112 are generally wedge-shaped, alternative embodiments may vary. For example, some alternative embodiments may include magnetization regions having no rotational symmetry, or magnetization regions which are generally non-rectilinear or non-parallelepipedal. In some alternative embodiments, at least a portion of a surface of a magnetization region may be non-parallel and non-perpendicular with at least another portion of a surface a magnetization region.

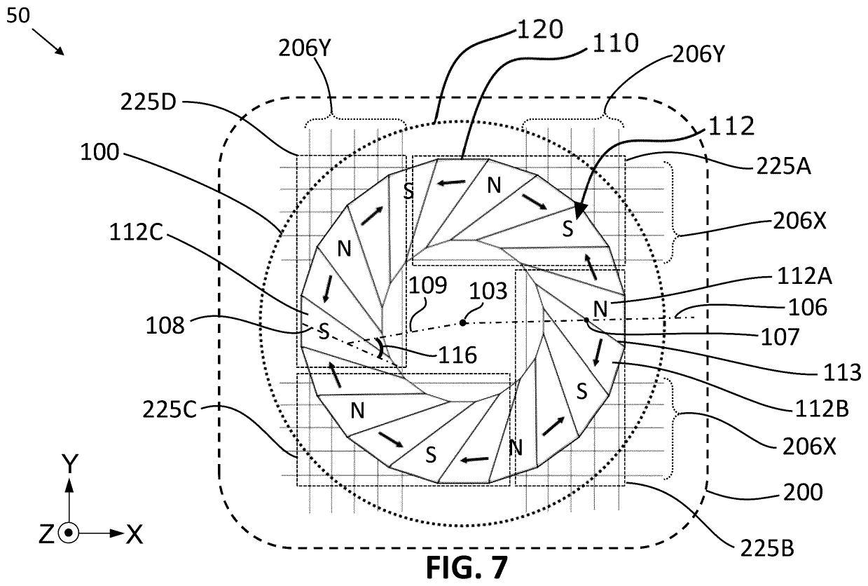

Referring now to FIG. 7, another non-limiting embodiment of the displacement system 50 of FIG. 1 is shown, and, as described above, includes the mover 100 and the stator 200. The embodiment of FIG. 7 is a variation of the embodiment shown in FIGS. 2 and 3, where the mover 100 includes an actuation magnet assembly 110 including a plurality of skewed magnetization regions 112. The skewed magnetization regions 112 are generally skewed relative to a radial direction from the reference point 103. As a result of this skew, boundary regions between adjacent magnetization regions of the plurality of skewed magnetization regions 112 are arranged such that each boundary region will intersect a straight line passing through the reference point 103 and through at least one of the adjacent magnetization regions bounded by that boundary region. For example, a boundary region 113 between skewed magnetization regions 112A and 112B, at an intersection point 107, intersects a line 106 which passes through the reference point 103 and through each of the magnetization regions 112A and 112B. In the embodiment shown, substantially all of each boundary region between adjacent magnetization regions intersects respective straight lines passing through the reference point 103 and through at least one of the adjacent magnetization regions bounded by the respective boundary region. However, alternative embodiments may differ. For example, in some alternative embodiments, only a portion of each boundary may intersect straight lines through the reference point 103 in this way. In other alternative embodiments, only some boundaries between adjacent magnetization regions may intersect straight lines through the reference point 103 in this way.

As shown in FIG. 7, each of the skewed magnetization regions 112 includes a centerline which extends generally equidistantly between a pair of adjacent ones of the at least five nonoverlapping paths bounding that skewed magnetization region 112. For example, magnetization region 112C includes a centerline 108. The centreline of each skewed magnetization region 112 intersects straight lines passing through the reference point 103 (i.e., radii from the reference point 103) at non-zero skew angles. For example, the centerline 108 of the magnetization region 112C intersects a straight line 109 from the reference point 103 at a skew angle 116. In the embodiment shown, the skewed magnetization regions 112 have centerlines which are generally straight. However, alternative embodiments may differ. For example, in some alternative embodiments, skewed magnetization regions may have centerlines which are partially or entirely curved, or centerlines which are arcuate.

As in the embodiment of FIGS. 2 and 3, the stator 200 of FIG. 7 includes a plurality of electrical conductors 206X oriented in the X-direction and a plurality of electrical conductors 206Y oriented in the Y-direction. In operation, the electrical conductors 206X and 206Y may be used to control sections of the actuation magnet assembly 110 (i.e., magnetization regions 112) which generally align with respective conductors. In some embodiments, the actuation magnet assembly 110 may be controlled with four subsets of conductors: two subsets of X-oriented conductors 206X and two subsets of Y-oriented conductors 206Y. By controlling all of these respective subsets of conductors in a synchronized manner, it may be possible to generate up to 6-DOF motion including full rotation about an axis in the Z-direction (i.e., Rz), where the circumferentially repeating pattern of magnetization regions 112 will create a generally consistent control relationship throughout rotation of the mover 100.

Also as in the embodiment of FIGS. 2 and 3, the plurality of skewed magnetization regions 112 of FIG. 7 is generally arranged into a ring or toroid. As such, each portion of the plurality of skewed magnetization regions 112 may be predominantly controlled by a particular overlapping area of X-or Y-oriented conductors 206X/206Y within that area. For example, a portion of the plurality of skewed magnetization regions 112 within area 225A may be predominantly controlled by the X-oriented conductors 206X overlapping with that area, and similarly a portion of the plurality of skewed magnetization regions 112 within area 225C may be predominantly controlled by the overlapping X-oriented conductors 206X. Likewise, portions of the plurality of skewed magnetization regions 112 overlapping with areas 225B and 225D may be predominantly controlled by their respective overlapping Y-oriented conductors 206Y. In some embodiments, a large enough skew angle can distinctly separate the subset of actuating conductors used by opposing regions of the plurality of skewed magnetization regions 112. In embodiments where all dominant actuation conductor regions are distinctly separate from each other, longer conductors may be acceptable for operating a single mover without a significant trade-off in actuating performance.

In some embodiments (not shown), skewed magnetization regions 112 may contain multiple actuation magnets 111, including, for example, combinations of wedge-shaped magnet pieces with other generally rectangular magnet pieces. In some embodiments, wedge-shaped magnet pieces may be alternated with generally rectangular magnet pieces.

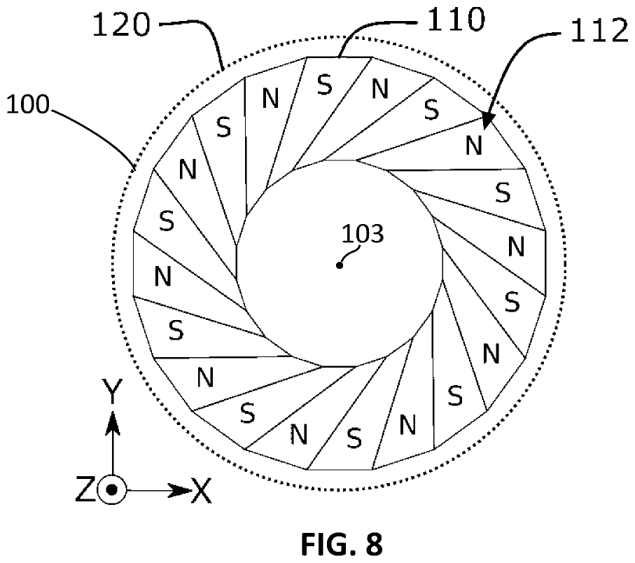

FIG. 8 depicts a non-limiting embodiment of the mover 100 of the displacement system 50 of FIG. 7. The mover 100 of FIG. 8 includes an actuation magnet assembly 110 with only two orientations of magnetization regions: one with North directed in the +Z-direction, and one South directed in the +Z-direction. Although a strength of a magnetic field produced by this embodiment may be reduced in comparison to using a Halbach array arrangement (on its strong side) as in FIG. 7, for example, the embodiment of FIG. 8 may have reduced complexity.

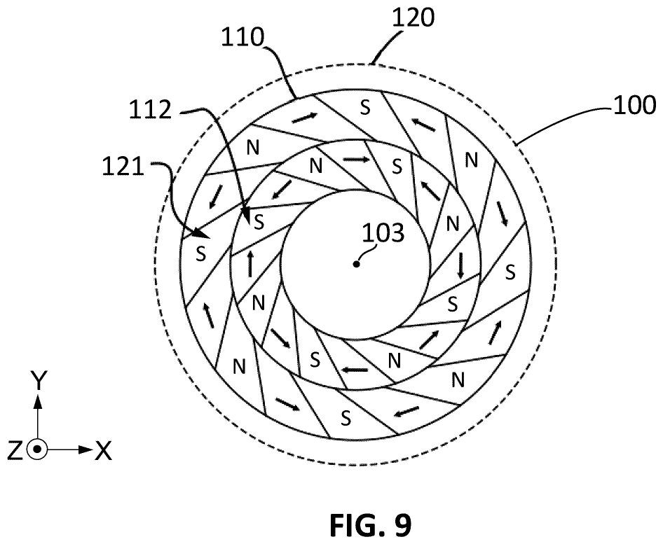

FIG. 9 shows a particular embodiment of the mover 100 with an actuation magnet assembly 110 which includes an inner primary plurality of skewed magnetization regions 112, which may be similar to the plurality of skewed magnetization regions 112 of the embodiment of FIG. 7, and an outer secondary plurality of skewed magnetization regions 121, which may be similar to the primary plurality of skewed magnetization regions 112, but larger. Inner skew angles of the primary plurality of skewed magnetization regions 112 may be different from outer skew angles of the secondary plurality of skewed magnetization regions 121. Such use of multiple skew angles for two concentric rings of magnetization regions (which may additionally be rotationally offset between each other) may create a magnet pattern where the controllability of the magnetization regions is more uniform over a larger range of Rz positions. Additionally, the use of multiple skew angles may create a curve effect in the magnetic field pattern, which may provide benefits for controllability at different positions or layouts, such as, for example, reducing the worst-case controllability over all X, Y, and Rz positions.

Although in the embodiment shown in FIG. 9, both concentric rings of magnetization regions have skewed magnetization region arrangements, alternative embodiments may differ. For example, in some alternative embodiments, one or both rings may include only radially oriented magnets (e.g., as in FIGS. 2 and 3). Additionally, some alternative embodiments may include more than two concentric rings of magnetization regions. As shown in FIG. 9, rotational offset between inner and outer rings may be used to achieve a desired magnetic field.

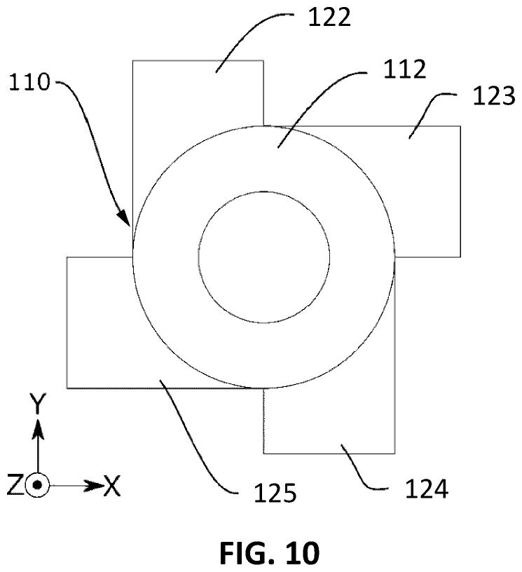

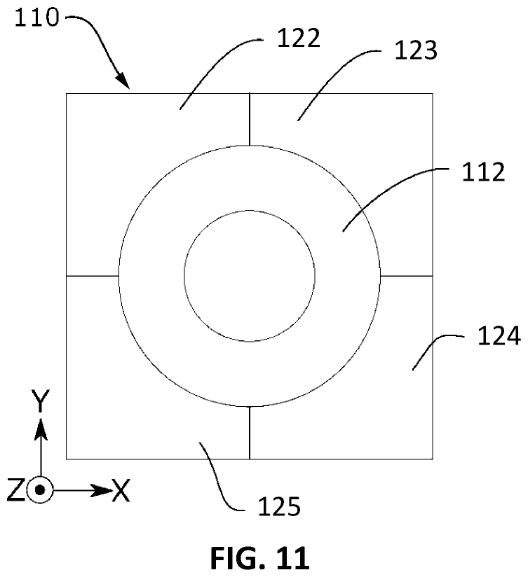

FIGS. 10 and 11 show two embodiments of the mover 100, each having an actuation magnet assembly 110 which includes a primary plurality of magnetization regions 112, which may be similar to the plurality of magnetization regions 112 of the embodiments of FIGS. 2, 3, 4, and/or 7, and secondary rectilinear pluralities of magnetization regions 122, 123, 124, and 125. In some embodiments, each of the secondary rectilinear pluralities of magnetization regions 122, 123, 124, and 125 may be arranged in a rectilinear grid. In some such embodiments, the rectilinear grids may be one dimensional—i.e., forming linear arrays of magnetization regions. In some such embodiments, the secondary rectilinear pluralities of magnetization regions 122, 123, 124, and 125 may be arranged to have each of the rotationally adjacent linear arrays be rotated with respect to each other, for example, at 90 degree offsets (e.g., such that the arrays 122 and 124 are oriented along the Y-direction, and the arrays 123 and 125 are oriented along the X-direction). By utilizing such hybrid arrangements of magnetization regions, it may be possible to achieve improved operating performance at specific orientations of mover 100 (e.g., at 0, 90, 180 and 270 degrees) for faster in-plane motion, with a potential trade-off of less efficient rotation motions. Although the hybrid mover embodiments shown in FIGS. 10 and 11 have the circumferential and linear magnetization region arrays physically joined, it should be understood that this is not required and in alternative embodiments the linear magnetization region arrays could be distinctly separated (but still attached via the mover frame 120) or entirely rectangular in shape.

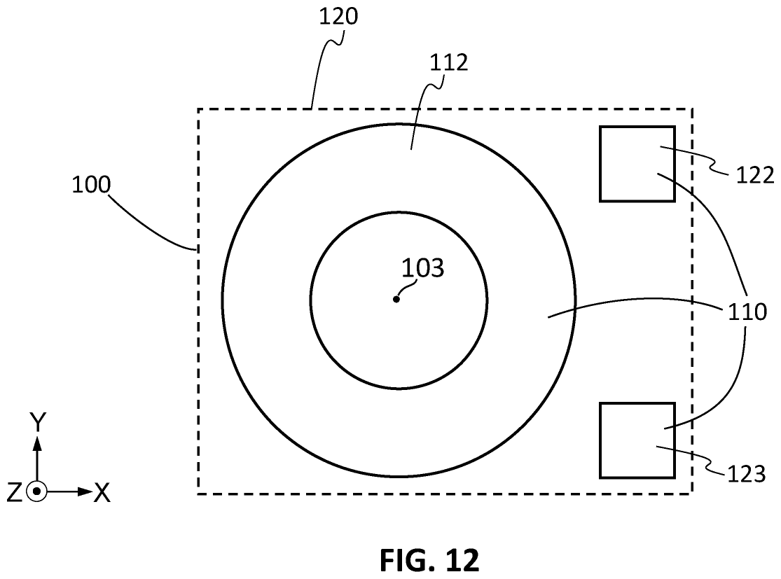

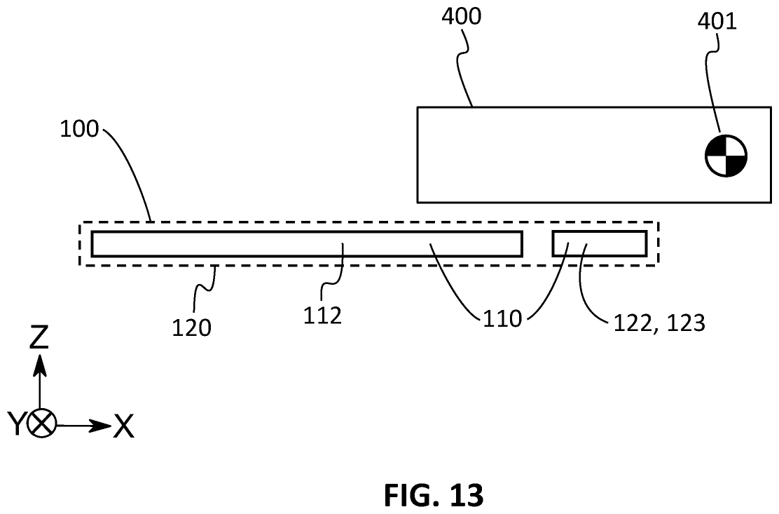

FIGS. 12 and 13 show another embodiment of the mover 100 with an actuation magnet assembly 110 which includes primary plurality of magnetization regions 112, which may be similar to the plurality of magnetization regions 112 of the embodiments of FIGS. 2, 3, 4, and/or 7, and secondary rectilinear pluralities of magnetization regions 122, 123, which may be similar to the pluralities of magnetization regions 122, 123, 124, and 125 of the embodiments of FIGS. 10 and 11. The pluralities of magnetization regions 112, 122, and 123 are collectively joined by the frame 120. In FIG. 13, the mover is depicted carrying a payload 400 with a cantilevered center of mass 401. By utilizing a hybrid arrangement of magnets as in this embodiment, it may be possible to improve operating performance for some payloads, such as payloads with highly offset center of masses and/or cantilevered payloads.

Additionally, hybrid magnetization region arrangements as shown in FIGS. 10 to 13 may be used to achieve greater operating efficiency at certain typical operating orientations, at a cost of reduced performance in certain other orientations. This may be desirable if most movements occur with a particular orientation (e.g., at 90 degree orientations aligning with X and Y directions).

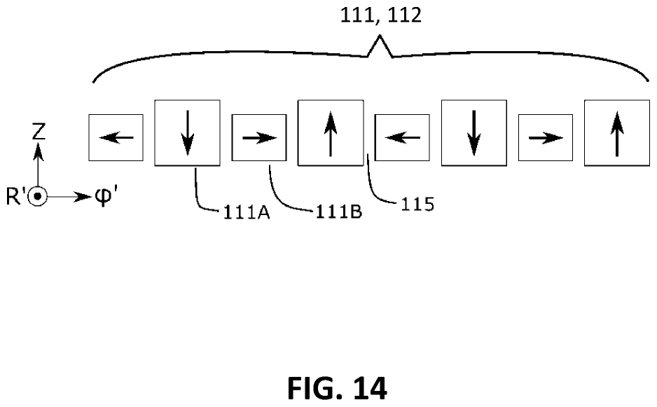

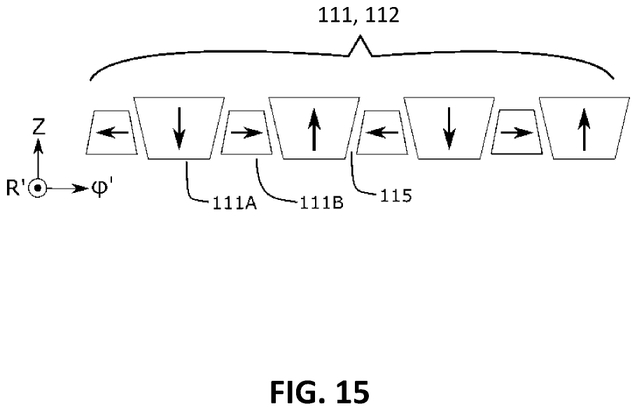

FIGS. 14 and 15 show two example magnetization region arrays 112 which include different variations of possible actuation magnet arrangements and shapes making up each of the magnetization regions of each array. In both FIGS. 14 and 15, the actuation magnets 111 are shown with respect to a coordinate system aligning with a length direction R′ of the actuation magnets 111 (which may, for example, describe the linear length, radius from circle, or a skewed radial length), a width Ψ′ of the magnetization region pattern (which may, for example, describe a linear width, a circumferential direction or skewed generally circumferential direction), and a vertical axis Z. In FIG. 14 the magnetization region array 112 comprises larger actuation magnet pieces 111A (thicker in Z and/or wider in Ψ′) and smaller actuation magnet pieces 111B (thinner in Z and/or narrower in Ψ′) arranged together. It will be appreciated that actuation magnet 111A may also be larger in one dimension and smaller in another; for example thicker in Z but also narrower in Ψ′. The use of both large and small actuation magnet pieces 111A/111B can selectively alter the magnetic field of the magnetization region array 112 by strengthening or weakening different regions. Additionally, a spacing 115 between adjacent actuation magnet pieces may be utilized in the construction of an array for reasons such as manufacturability. In FIG. 15, the large and small magnetic segments 111A/111B are additionally trapezoidal in shape. It will be appreciated that other embodiments may also have other non-rectangular shapes, such as circular or other curved shapes. In some cases, the use of a trapezoidal magnet shape or otherwise non-rectangular shape may be used to improve the magnetic field pattern for a particular usage (such as increasing peak magnetic intensity on a strong side of the pattern, for example).

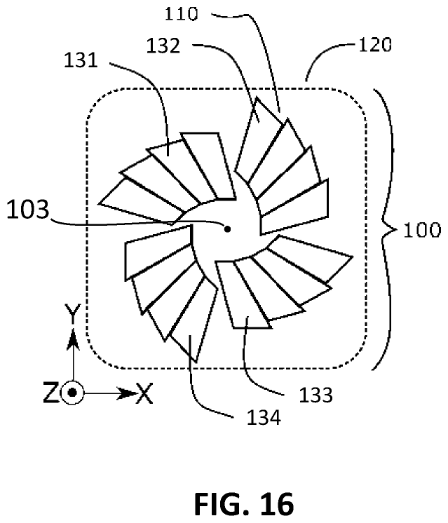

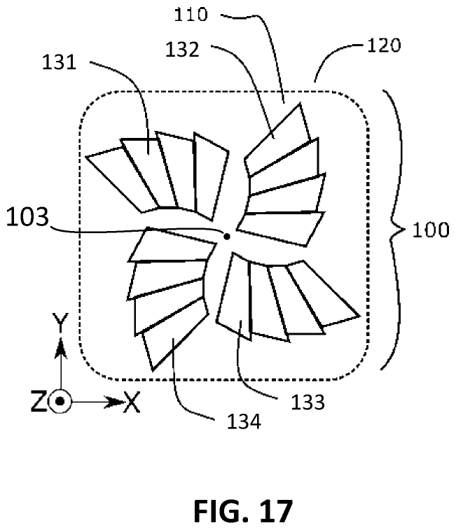

FIGS. 16 and 17 show two non-limiting embodiments of the mover 100 having skewed magnetization region arrangements similar to that of the embodiments of FIG. 7 or 8. In FIGS. 16 and 17, the mover 100 has an actuation magnet assembly 110 which includes four segments of skewed magnetization region arrays 131, 132, 133, and 134 held together by a frame 120. Each of the segments is arranged to be rotated a fixed amount, such as 90 degrees, relative to adjacent segments. Orienting the magnetization regions in this way may allow efficient generation of forces when the mover 100 is near Rz positions of 0, 90, 180 and 270 degrees, such that motion near these “standard” angular positions (in particular the in-plane motion, but up to 6-DOF motion) may be considered typical operation for this mover embodiment. Furthermore, during large rotation motions about the vertical axis between the standard angular positions, the mover 100 may provide improved functionality over standard magnetization region arrays by having a range of regions with different magnetic pitches that align effectively with stator conductors at specific positions. An increase in operating efficiency at a larger range of vertical rotation positions Rz may improve an overall large rotation performance, which may be worth any potential reduction in normal orientation performance comprising up to 6-DOF motions for some applications.

Although the embodiments shown in FIGS. 16 and 17 include separations between adjacent magnetization region arrays 131, 132, 133, and 134, in some alternative embodiments such magnetization region arrays could contact each other and boundary magnets could be shaped to conform with the adjacent magnet arrays.

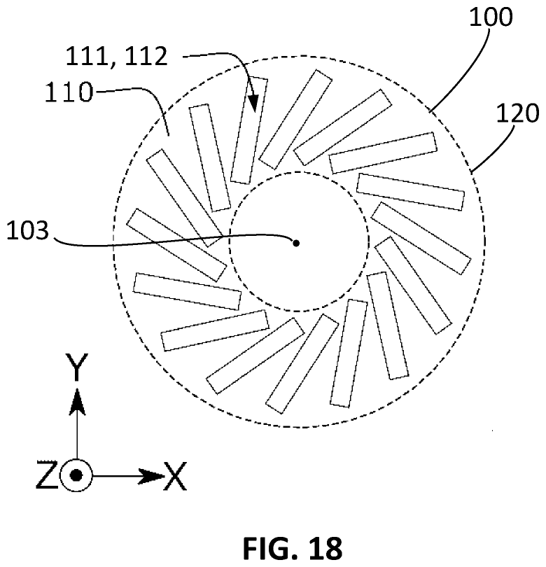

FIG. 18 depicts another non-limiting embodiment of the mover 100 with an actuation magnet assembly 110 including a plurality of rectangular actuation magnets 111 arranged in a skewed radial pattern. Each of the actuation magnets 111 may have a particular magnetization direction and generally corresponds to a respective magnetization region 112 of the actuation magnet assembly 110. The actuation magnets 111 may be arranged in a Halbach array pattern to generate a larger magnetic field on a bottom side of the mover 100, for example. Use of rectangular actuation magnets may be beneficial for manufacturability, but may also potentially reduce efficiency due to the large gaps between adjacent skewed actuation magnets 111. Use of such rectangular actuation magnets may also provide limited design flexibility in the magnetic field generated by the actuation magnets 111.

In some embodiments, the skewed magnet arrays may have a variable magnetic pitch (in width or Ψ′ direction) along their length and the specific size and arrangement of magnetic parts 111 may be chosen to create an ideal magnetic pitch matching with the stator's conductor arrangement within the array. In some embodiments, an ideal magnetic pitch may occur near the mid-length of the array.

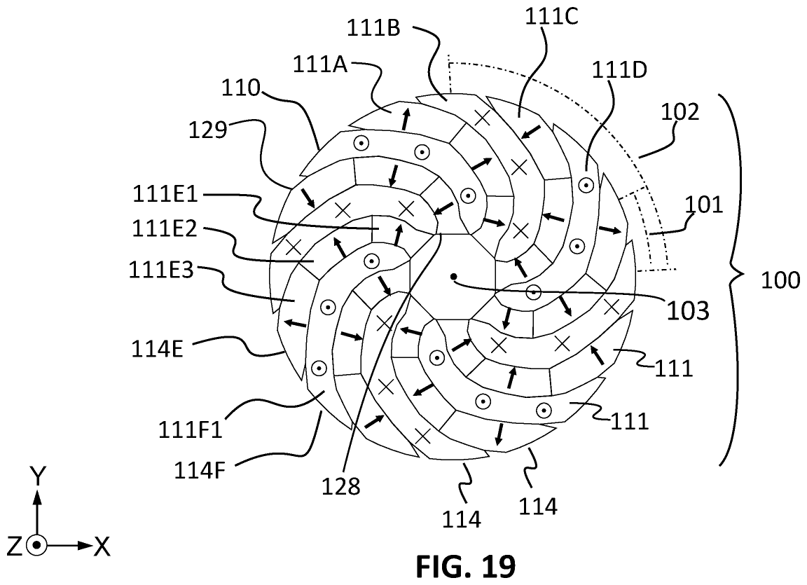

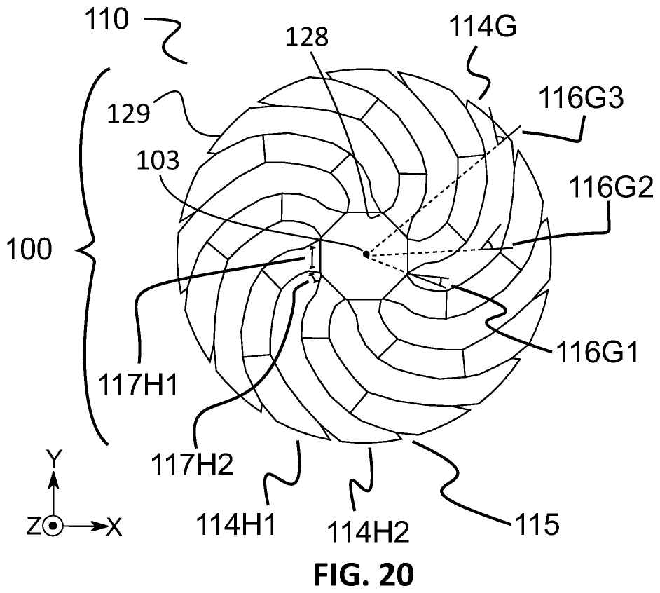

FIGS. 19 and 20 show a non-limiting embodiment of the mover 100 with an actuation magnet assembly 110 comprising a plurality of actuation magnets 111 with generally skewed and curved geometry. Each of the actuation magnets 111 has a particular magnetization direction and generally corresponds to a respective magnetization region 112 of the actuation magnet assembly 110. Magnets depicted with arrows, such as actuation magnet 111A, are magnetized in the corresponding direction. Magnets depicted with X (cross) markings, such as actuation magnets 111B and 111C, are magnetized into the page (i.e., in the −Z-direction). Magnets depicted with circle-and-dot markings, such as actuation magnet 111D, are magnetized out of the page (i.e., in the +Z-direction).

In some embodiments, the actuation magnet assembly 110 may be rotationally symmetric. That is, in such embodiments the actuation magnet assembly 110 may appear exactly the same after a rotation by some angle less than a full turn around a center of the actuation magnet assembly 110 at the reference point 103. In some such embodiments, the actuation magnet assembly 110 may be rotationally symmetric with a period equal to the angular period 102. In some embodiments, the actuation magnet assembly 110 may be rotationally anti-symmetric. That is, in such embodiments the magnetization of all actuation magnets 111 in the actuation magnet assembly 110 may appear reversed when the actuation magnet assembly 110 is rotated by some angle less than a full turn around the center of the actuation magnet assembly 110 at the reference point 103, and the resulting magnetic field generated by the actuation magnet assembly 110 becomes inverted at all points. Generally, rotational symmetry and rotational anti-symmetry of the actuation magnet assembly 110 may have an effect of simplifying sensing and control, as sensing and control algorithms may take advantage of the symmetry to reduce the effective complexity of different possible configurations of the mover 100.

In the embodiment shown in FIG. 19, the actuation magnet assembly 110 has both rotational symmetry and rotational anti-symmetry. More specifically, in the embodiment shown, the actuation magnet assembly 110 has rotational symmetry of order 4 (i.e., the actuation magnet assembly 110 appears the same after rotating by ¼ of a full turn). However, ¼ in alternative embodiments, the actuation magnet assembly may an order of rotational symmetry that us lower or higher than 4. Also in the embodiment shown, the actuation magnet assembly 110 is rotationally anti-symmetric with a period of exactly half of the angular period 102. That is, rotating the actuation magnet assembly 110 by half of the angular period 102 around the reference point 103 causes the magnetic field generated by actuation magnet assembly 110 to be inverted at all points. It will be appreciated that in other embodiments, anti-symmetry may occur with a period other than half of the angular period 102. It will also be appreciated that even if an embodiment is not rotationally symmetric, it may nevertheless be substantially rotationally symmetric. A small amount of asymmetry may be introduced intentionally, such as to provide a method to detect absolute orientation, or unintentionally, such as due to manufacturing variations. An embodiment with a small amount of asymmetry may have most of the advantages of being rotationally symmetric.

It will be appreciated that rotational anti-symmetry arises in the actuation magnet assembly 110 of the embodiment shown because the actuation magnet assembly 110 includes an even number of magnetization regions 112 (corresponding to the even number of respective actuation magnets 111) per magnetic period 102. More specifically, in the embodiment shown, there are four magnetization regions 112 per magnetic period 102. In general, exact rotational anti-symmetry will not occur if there is an odd number of magnetization regions 112 per magnetic period 102. However, it will be appreciated that approximate rotational anti-symmetry may still be present when there is an odd number of magnetization regions 112 per magnetic period 102; that is, in such arrangements, rotating the actuation magnet assembly 110 around the reference point 103 may cause the magnetic field generated by the actuation magnet assembly 110 to be substantially inverted at all points.

In the embodiment shown, the actuation magnets 111, and thus their corresponding magnetization regions 112, may be grouped into a plurality of magnet fingers 114, where each magnet finger 114 comprises one or more actuation magnets 111 that form a contiguous set of magnets from an inner boundary 128 of the actuation magnet assembly 110 to an outer boundary 129 of the actuation magnet assembly 110 (the outer boundary 129 generally corresponding to the periphery 105 of the magnetization regions 112 of the actuation magnet assembly 110). For example, magnet finger 114E comprises actuation magnets 111E1, 111E2, and 111E3, and magnet finger 114F comprises actuation magnet 111F1. It will be appreciated that the geometry of the actuation magnet assembly 110 may be defined by the geometry of all of the magnet fingers 114.

It will also be appreciated that defining a geometry of a magnet finger 114 as a general curved surface may allow for fine-tuned geometry optimization to maximize or minimize desirable performance metrics of the mover 100, such as minimizing a current required to levitate a particular payload. For magnet fingers 114 which include horizontally (i.e., in the X-Y plane) magnetized actuation magnets 111, such as magnet finger 114E, which includes horizontally magnetized actuation magnets 111E1, 111E2, and 111E3), it will be appreciated that the division of the magnet finger 114 into more than one actuation magnet 111 may confer further freedom in geometry optimization, in that both specific (generally horizontal) directions of magnetization and relative sizes of actuation magnets 111 may be varied to maximize or minimize desirable performance metrics. However, it will also be appreciated that magnet fingers 114 including horizontally magnetized actuation magnets 111 may include only one actuation magnet 111 (e.g., by merging the horizontally magnetized actuation magnets 111E1, 111E2, and 111E3 into a single actuation magnet), which may simplify assembly.

Additionally, although magnet fingers 114 which include multiple horizontally magnetized actuation magnets 111 having different magnetization directions within the horizontal (i.e., X-Y) plane may be considered as including multiple magnetization regions 112 due to their constituent actuation magnets 111 having different respective magnetization directions, such magnet fingers 114 may also be considered to include only a single magnetization region 112 having a generally horizontal magnetization direction. For example, in the magnet finger 114E, each of the actuation magnets 111E1, 111E2, and 111E3 may be considered to correspond to its own separate magnetization region 112, such that the magnet finger 114E includes three magnetization regions 112. Alternatively, the three actuation magnets 111E1, 111E2, and 111E3 may be considered to make up a single magnetization region 112, such that the magnet finger 114E includes only one magnetization region 112 having a magnetization direction in the horizontal (i.e., X-Y) plane that is generally peripheral (i.e., circumferential) to the overall actuation magnet assembly 110.

Similar to the angular pitch 101 of magnetization regions 112 in the embodiment of FIGS. 2 and 3, an angular pitch 101 of the magnet fingers 114 may be defined as an angle between centerlines of adjacent magnet fingers, relative to the center of magnetic assembly 110 at the reference point 103. Similarly, an angular period 102 of the magnet fingers 114 may be defined as an angle between adjacent magnet fingers 114 with the same magnetization, relative to the center of magnetic assembly 110 at the reference point 103. It will be appreciated that, in the embodiment shown in FIGS. 19 and 20, the angular pitch 101 and angular period 102 remain generally constant with respect to radial position.

Although in the embodiment shown in FIGS. 19 and 20, magnet fingers 114 including vertically (i.e., in a +Z or −Z direction) magnetized actuation magnets 111, such as magnet finger 114F which includes actuation magnet 111F1, generally include only a single actuation magnet 111, it will be appreciated that in alternative embodiments, such magnet fingers 114 may be broken into more than one actuation magnet 111, for example to improve ease of manufacturing or assembly.

Although in the embodiment shown in FIGS. 19 and 20, magnet fingers 114 are generally divided into individual actuation magnets 111 by straight lines, it will be appreciated that in alternative embodiments, curved cuts may be used instead, for example to improve ease of assembly or to confer further freedom in geometry optimization.

Although in the embodiment shown in FIGS. 19 and 20, actuation magnets 111 are only shown magnetized either vertically or horizontally, it will be appreciated that actuation magnets 111 may also be magnetized in other directions, such as diagonally or radially, or in general in arbitrary directions in 3D space, to confer further freedom in design optimization or improve manufacturability, for example.

In FIG. 20, annotations for magnetization direction have been removed for clarity. As demonstrated in FIG. 20, the geometry of a magnet finger 114 may be parameterized by its skew angle 116, as a function of radial distance from the center of the magnet assembly 110 at the reference point 103. Here, skew angle 116 is defined as the angle between a radial line through the reference point 103 and a tangent line of the centerline of a magnet finger 114. For example, magnet finger 114G has different skew angles 116G1, 116G2, and 116G3 at different radii from the center of the magnet assembly 110. Although three skew angles 116 are shown in FIG. 20 for the magnet finger 114G, it will be appreciated that fewer or more skew angles may be defined for any given magnet finger 114.

As also demonstrated in FIG. 20, a relative width of magnet fingers 114 may be variable. For example, near the inner boundary 128, a width 117H1 of magnet finger 114H1 is significantly larger than a width 117H2 of magnet finger 114H2. The relative widths of magnet fingers 114 may be varied to give more freedom in geometry optimization.

Although magnet finger 114 width may vary along a length of the magnet finger 114, it should be appreciated that a magnet finger 114 width along its length may also be generally uniform. A benefit of the skew angle may be that an actuation magnet width for a given location may be shorter than that measured for the same radial location when measured orthogonal to the radial direction. Where a larger skew angle may occupy a larger circumferential distance for the same width, by increasing the skew angle at further radial locations of the magnet piece a local width of the magnet finger 114 can be maintained. One benefit of this characteristic is that it may be possible to create larger effective regions where a magnetic pitch is close to a desired value. In general, to achieve efficient force generation it may be desirable to have a large percentage of the magnet aligning with coils extending in either a first direction (i.e., X-direction) or a second direction (i.e., Y-direction). Additionally, if these effective regions have a magnetic pitch that corresponds well with a conductor spacing, it may be beneficial for generating forces with those coils.

In some embodiments, magnet fingers 114 comprising actuation magnets 111 with at least a direction component that is horizontal may vary their magnetic orientation to be generally orthogonal to the skew angle with respect to a center of that actuation magnet 111.

FIG. 20 also shows that a gap 115 may be introduced between adjacent magnet fingers 114. Such gaps may be introduced, for example, to limit the curvature of a magnet finger 114 and/or its component actuation magnets 111, in order to improve ease of manufacture, for example. Such gaps may also be introduced in order to reduce weight of the mover 100 or improve performance characteristics of the mover 100. It will be appreciated that although FIG. 20 shows the gap 115 only at the outer boundary 129 of the actuation magnet assembly 110, a gap 115 may be introduced at any point along the length of a magnet finger 114. A small gap 115 between adjacent magnet fingers 114 may also be used to facilitate bonding during manufacturing of the actuation magnet assembly 110.

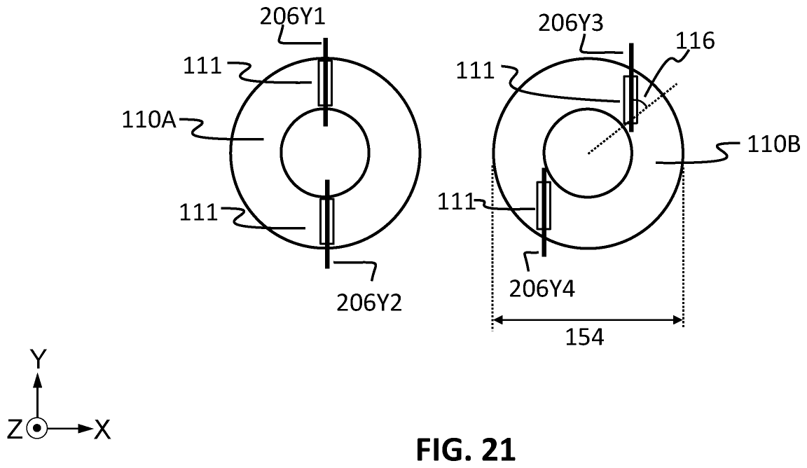

FIG. 21 demonstrates the effect of introducing a skew angle 116. On the left, actuation magnet assembly 110A comprises actuation magnets 111 which are not skewed. As a result, electrical conductors 206Y1 and 206Y2 are co-linear. Therefore, there is a constraint on the maximum length of electrical conductors 206Y1 and 206Y2 if magnet assembly 110A is to have both −Y and +Y sides be independently controllable at all positions. In contrast, on the right, actuation magnet assembly 110B comprises magnetic pieces 111 which have a skew angle 116. As a result, electrical conductors 206Y3 and 206Y4 are not colinear. Therefore, it becomes possible to independently control two halves of the actuation magnet assembly 110B with electrical conductors 206Y3 and 206Y4, which are longer than an outer diameter 154 of magnet assembly 110B.

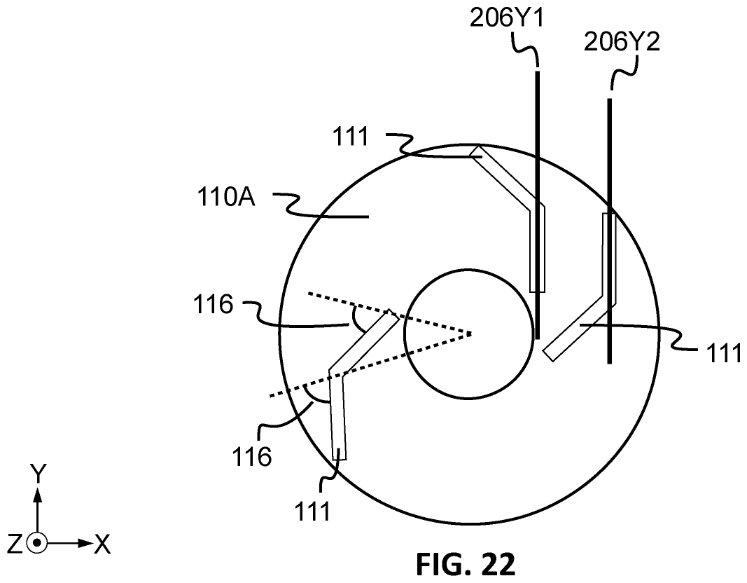

FIG. 22 demonstrates the effect of utilizing actuation magnets 111 with multiple skew angles 116. By using actuation magnets 111 with multiple skew angles 116, a single actuation magnet 111 may be generally alignable with electrical conductors 206 at multiple Rz values. In this demonstration, the actuation magnet 111 may be aligned with electrical conductor 206Y1 at one Rz value and with electrical conductor 206Y2 at a different Rz value.

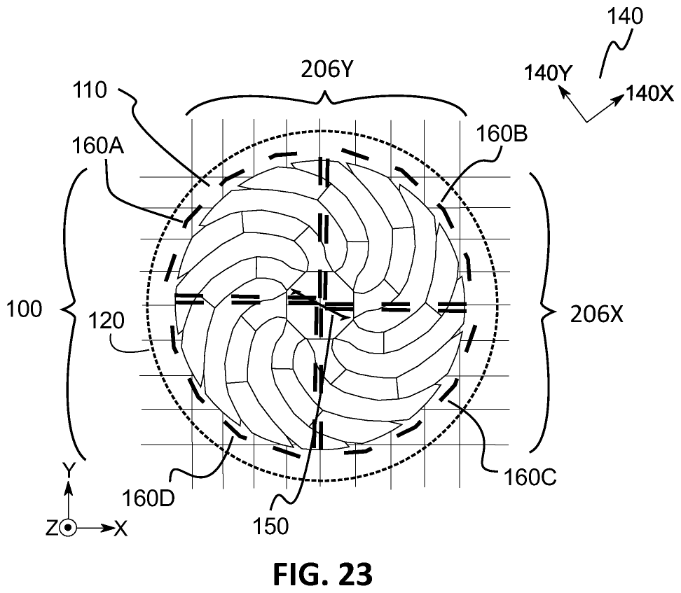

FIG. 23 depicts the embodiment of FIGS. 19 and 20, and demonstrates how the stator 200 may be controlled to interact with the mover 100, specifically through the pluralities of electrical conductors 206X and 206Y. The X-oriented electrical conductors 206X may be able to impart Y, Z, Rx, Ry, and Rz forces on the mover 100, and the Y-oriented electrical conductors 206Y may be able to impart X, Z, Rx, Ry, and Rz forces on the mover 100. However, as depicted in FIG. 23, the X-oriented electrical conductors 206X primarily generate forces in an upper left region 160A and a lower right region 160C of the mover 100, and Y-oriented electrical conductors 206Y primarily generate forces in an upper right region 160B and a lower left region 160D of the mover 100. As a result, it may be useful to define a rotated coordinate axis 140. The X-oriented electrical conductors 206X are generally capable of generating moments about axis 140X and less capable of generating moments about axis 140Y. The Y-oriented electrical conductors 206Y are generally capable of generating moments about the axis 140Y and less capable of generating moments about the axis 140X.

Because the regions 160A and 160C are offset from each other in the Y-direction, the X-oriented electrical conductors 206X may generally be able to apply forces in these regions independently, and it may not be necessary to split X-oriented electrical conductors 206X along their length. Similarly, because the regions 160B and 160D are offset from each other in the X-direction, Y-oriented electrical conductors 206Y may generally be able to apply forces in these regions independently, and it may not be necessary to split Y-oriented electrical conductors 206Y along their length. As a result, there may be no immediate constraint on an inner diameter 150 of the actuation magnet assembly 110. In particular, the inner diameter 150 may be significantly smaller than a length of the electrical conductors 206. Although some regions may be better at generating forces with particular X-oriented or Y-oriented conductors, it should be understood that forces may still be generated with the other set of conductors. However, efficiency and force produced may be lower.

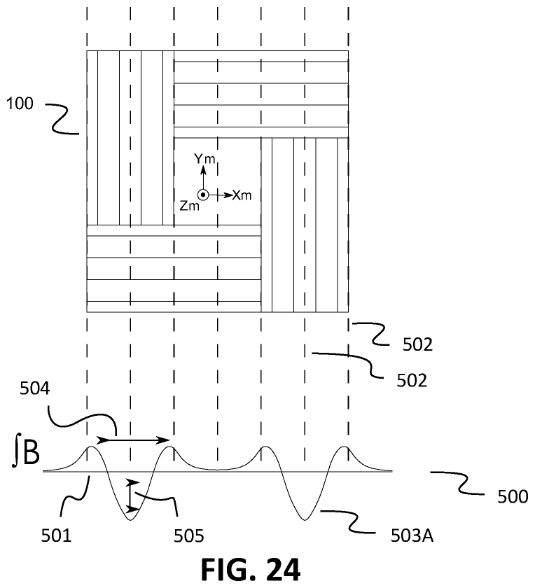

FIGS. 24 through 27 may be useful in helping to explain why movers 100 with skewed magnetization regions/actuation magnets provide improvements in performance at variable rotation angles.

FIG. 24 depicts a mover 100 with an actuation magnet assembly 110 which includes Halbach arrays. Plot 500 is obtained by integrating the magnetic field under the mover 100 along dashed lines 502, for many X-positions; this produces plotline 503A. Since the force generated by an electromagnetic coil carrying current is generally proportional to magnetic field, the plot 500 may serve as a proxy for the amount of force that may be generated by one unit of current in an electrical conductor. It should be noted that the magnetic field is a 3-dimensional vector field, and the plot 500 only shows the result of integrating the Z-component of the magnetic field, corresponding to X-force generation. However, it will be appreciated that similar plots with similar characteristics may be generated for the X-component of the magnetic field, which corresponds to Z-force generation. Plotline 501 is the X-axis of the plot 500, indicating an integrated magnetic field of 0. Additionally, a similar plot could be generated for Y-force generation by integrating along various Y-positions.

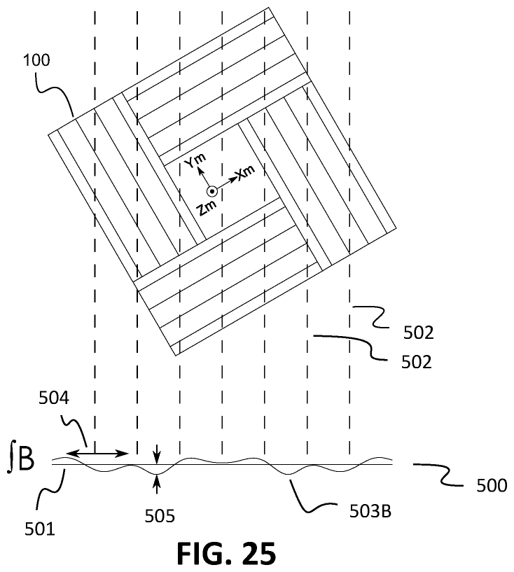

It will be appreciated that since electrical conductors may be generally designed to output current in a sinusoidal pattern with respect to lateral position, in order to maximize force generation, the plotline 503A may be approximately sinusoidal, with a period 504 matching that of the coils, and having high amplitude 505. As depicted in FIG. 24, when the mover 100 is aligned with the coils (i.e., no rotation), the plotline 503A has these characteristics.
FIG. 25 depicts the same mover 100 as in FIG. 24, but at a non-negligible rotation in Rz (i.e., around an axis in the Z direction). The plot 500 in FIG. 25 is generated in the same way as in FIG. 24. It will be appreciated that plotline 503B has a much smaller amplitude 505 than the plotline 503A, and that the period 504 of plotline 503B is different from that of 503A (i.e. the period 504 of plotline 503B will not have a period matching that of the coils). This indicates that it may be very difficult to generate forces on the mover 100 as depicted in FIG. 25. Due to this difficulty in generating forces, a very large amount of current may be required to generate the minimum required forces for control (and levitation) of the mover 100 and its payload.

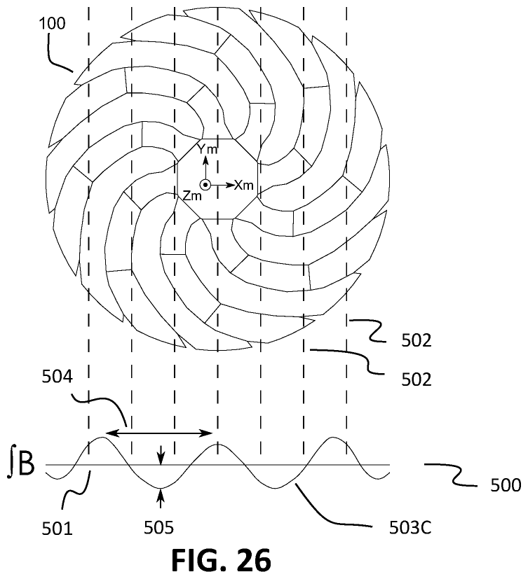

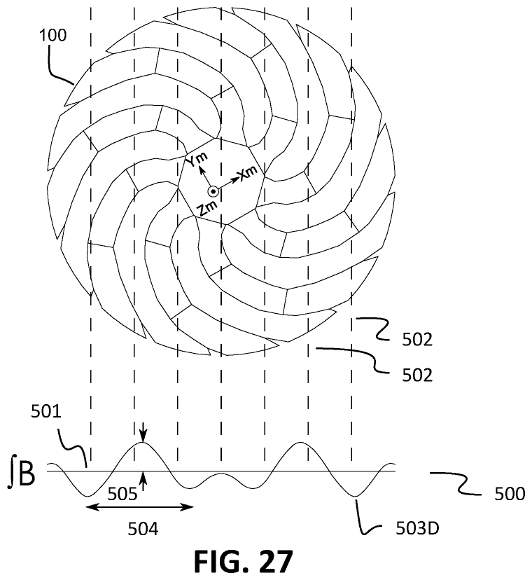

FIG. 26 and FIG. 27 both depict a mover 100 with skewed magnets, similar to the mover 100 of the embodiment of FIGS. 19 and 20. FIGS. 26 and 27 demonstrate that for such a mover 100, regardless of rotation in Rz, the mover 100 generates a plotline of the form of plotlines 503C and 503D, both of which have high amplitude 505 and a period 504 matching that of the electrical conductors. Therefore, with the mover 100 of this embodiment, it may be feasible to generate forces on the mover 100 regardless of rotation in Rz.

Although FIGS. 26 and 27 depict a mover 100 similar to the mover 100 of FIGS. 19 and 20, it will be appreciated that similar conclusions may be drawn about other embodiments such as those described above.

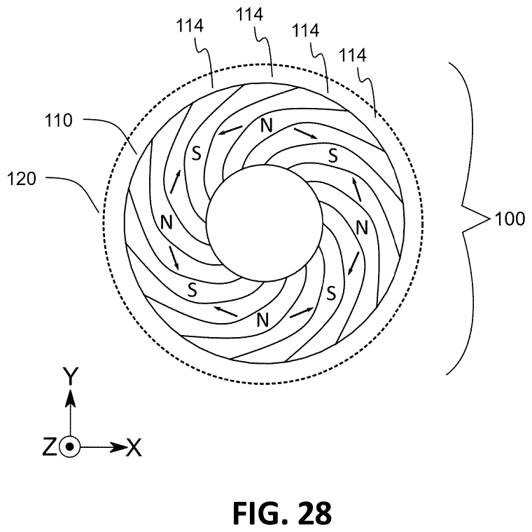

FIG. 28 shows a variation of the mover 100 of FIGS. 19 and 20, where the mover 100 has an actuation magnet assembly 110 which includes magnet fingers 114 each including only a single actuation magnet 111. The mover 100 of FIG. 28 may be more limited in terms of possible magnetic field patterns of the actuation magnet assembly 110, compared to other embodiments which include multiple actuation magnets 111 along a magnet finger 114.

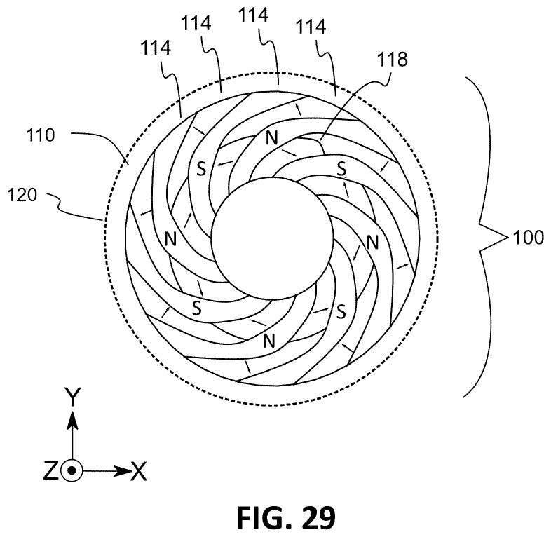

FIG. 29 shows another variation of the mover 100 of FIGS. 19 and 20, where the mover 100 has an actuation magnet assembly 110 which includes magnet fingers 114 each including multiple actuation magnets 111, and where an inter-magnet boundary 118 between adjacent actuation magnets 111 in a magnet finger 114 is not a straight line.

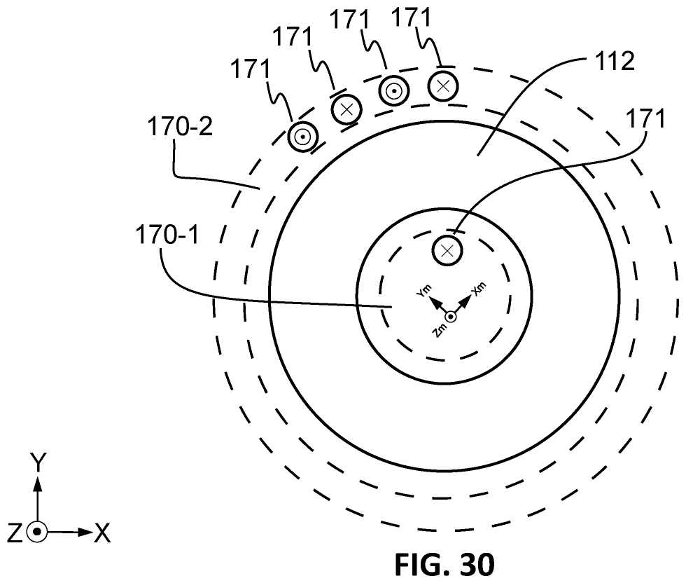

FIG. 30 shows another non-limiting embodiment of the mover 100 which includes features for identifying an orientation of the mover using an actuation magnet having a repeating pattern (i.e., rotationally symmetric). In this embodiment, the mover 100 includes one or more orientation identification magnets 171 located in a center region of the mover 170-1, an outer region of the mover 170-2, or both regions 170-1 and 170-2. In some embodiments, the actuation magnet assembly 110 may include a pattern of magnetization regions 112 which creates a magnetic field of the mover 100 which may be similar for multiple rotational positions of the mover 100 with respect to a vertical axis of the stator. Using one or more orientation identification magnets 171 may allow the stator sensors to differentiate between two or more similar potential positions for the mover 100.

In some embodiments, a mover like the mover 100 of FIG. 30 may utilize an eccentric position or shape of a magnetization region 112 to make a particular orientation appear different from other orientations when measured by the sensor 202.

In some embodiments, the pattern of magnetization regions 112 in the actuation magnet assembly 110 may repeat following a particular pattern. For example, the magnetization regions 112 may repeat 4 times, where the corresponding actuation magnets 111 for a particular orientation may have four different rotation positions that may be indistinguishable from each other by the sensor.

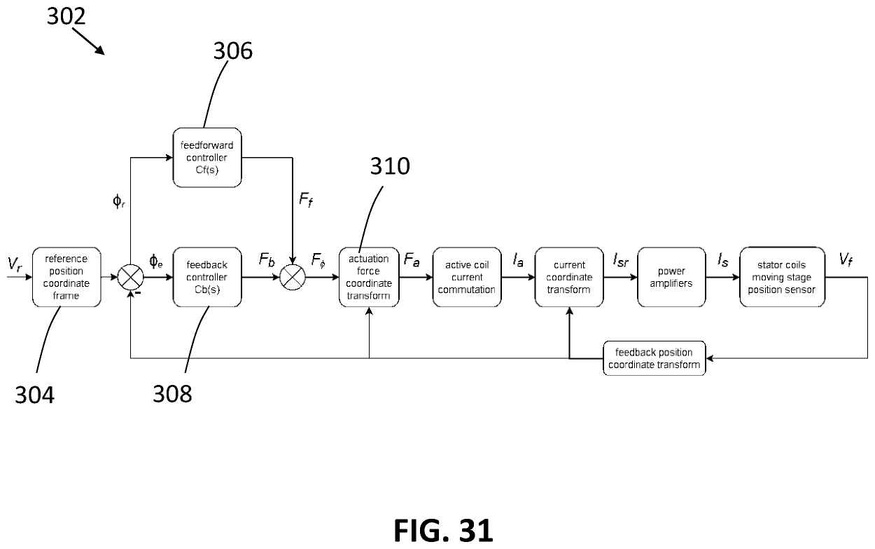

Referring now to FIG. 31, a schematic block diagram of control system according to one embodiment is shown generally at 302. The control system 302 may be implemented by the controller 300 to control the stator 200 to control motion of the mover 100, as described above.

The controller 300 may be programmed to control the mover 100 motion by comparing a reference position of the mover 100, represented by a reference position coordinate frame block 304, to a feedback position of the mover obtained from sensor data from the sensor 202 of the stator 200, thereby determining a desired resulting motion vector which may be achieved using a combination of the feedforward controller 306 and feedback controller 308 to calculate a modal domain force/torque vector F_{φ}. More specifically, the feedforward controller 306 may determine a feedforward force F_{f}, the feedback controller 308 may determine a feedback force F_{b}, and the modal domain force/torque vector may be calculated as F_{φ}=F_{f}+F_{b}.

In some embodiments, such as those of FIGS. 7, 9, 18, 19, 28, and 29, for example, it may be desirable for the controller 300 to rapidly determine a current commutation for a particular position and orientation of the mover 100. In some embodiments, these values may be looked up in a database for a particular combination of mover position and mover orientation values. By predetermining a range of values to facilitate commutation, the required calculations can be done very quickly enabling a high control frequency of the control system 302.

In some embodiments, the actuation magnet assembly 110 of the mover 100 may be broken up into a plurality of zones for the purposes of control, where such zones are useful for generating force in one or more particular directions. When the control system 302 calculates the desired modal domain force/torque vector F_{φ} to control the mover 100, an actuator force co-ordinate transform block 310 may be used to convert the modal domain force/torque vector F_{φ} into force commands for each particular zone of the actuation magnet assembly. In some embodiments, the zones used to generate forces may be fixed (generally) relative to the mover 100, for example, having to do with a particular repeating magnetic field pattern of the actuation magnet assembly 110 and a respective useful generating force varying in a given direction at different Rz positions of the mover 100. In some other embodiments, the particular magnet zones may generally be fixed to a section of the mover 100 as observed by the stator 200, as shown in FIG. 23, for example (see lower left region 160D).

A model of the force to current relationship for the desired zone of magnet at the current position and orientation relative to the stator conductor generating force in their particular generation. In some embodiments, such as the embodiment of FIG. 19, the rotational symmetry of the actuation magnet assembly 110 allows each repeating segment of the actuation magnet assembly 110 to be treated identically, having a particular resulting force created by running current through a conductor of the stator 200 at a particular relative position and orientation to the segment. The individual calculated currents to generate the desired force for each of the zones of the magnet may be combined together (e.g., by summing) to get a total desired current for each conductor.

Currents Iₐ for controlling the mover 100 may be converted into stator conductor reference commands Iₛᵣ by identifying which conductors have an associated command current Iₐ and summing all associated currents for each conductor. If a conductor doesn't have an associated command current, then it should be set to 0 to avoid unnecessary power consumption. The combined stator reference command for the mover 100 on the stator 200 being controlled by the controller 300 may be used by the one or more power amplifiers of the stator 200 to control motion of the mover 100. The actual current Iₛ created by the power amplifiers may be different than the desired stator coil reference command Iₛᵣ.

All 6 (or more, or fewer) degrees-of-freedom of the actuation magnet assembly 110 of the mover 100 may be measured for optimum motion control of the mover 100. In some embodiments, the actuation magnet assembly 110 may be treated as a whole for the purposes of position and orientation identification. In alternative embodiments, the respective position and orientation of a number of magnetic zones may be used to identify different spatial information of the mover which is combined to determine a position and orientation of the entire mover 100.

For the purposes of control, the output position feedback V_{f} may be converted to feedback position values φ_{f} for the 6 states defining rigid body motion (3 translational states and 3 rotational states). Additionally flexible vibration mode states may also be used as feedback values.

### Clauses

This disclosure includes but is not limited to the following clauses, which may be combined with other subject matter in this specification.

1. A mover operable to move in response to at least one external magnetic field, the mover comprising:
at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction,
wherein:
at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions; and
at least a portion of at least one boundary region between adjacent magnetization regions of the plurality of magnetization regions intersects a straight line passing through the reference point and through at least one of the adjacent magnetization regions bounded by the at least one boundary region.

2. The mover of clause 1 wherein the at least five nonoverlapping paths are in a common plane.

3. The mover of clause 1 or 2 wherein the at least five nonoverlapping paths comprise at least six nonoverlapping paths intervening between respective different pairs of adjacent magnetization regions of the plurality of magnetization regions.

4. The mover of clause 1 or 2 wherein the at least five nonoverlapping paths comprise at least seven nonoverlapping paths intervening between respective different pairs of adjacent magnetization regions of the plurality of magnetization regions.

5. The mover of clause 1 or 2 wherein the at least five nonoverlapping paths comprise at least eight nonoverlapping paths intervening between respective different pairs of adjacent magnetization regions of the plurality of magnetization regions.

6. The mover of clause 1 or 2 wherein the at least five nonoverlapping paths comprise at least nine nonoverlapping paths intervening between respective different pairs of adjacent magnetization regions of the plurality of magnetization regions.

7. The mover of clause 1 or 2 wherein the at least five nonoverlapping paths comprise at least ten nonoverlapping paths intervening between respective different pairs of adjacent magnetization regions of the plurality of magnetization regions.

8. The mover of clause 1 or 2 wherein the at least five nonoverlapping paths comprise at least twelve nonoverlapping paths intervening between respective different pairs of adjacent magnetization regions of the plurality of magnetization regions.

9. The mover of clause 1 or 2 wherein the at least five nonoverlapping paths comprise at least sixteen nonoverlapping paths intervening between respective different pairs of adjacent magnetization regions of the plurality of magnetization regions.

10. The mover of clause 1 or 2 wherein the at least five nonoverlapping paths comprise at least twenty nonoverlapping paths intervening between respective different pairs of adjacent magnetization regions of the plurality of magnetization regions.

11. The mover of clause 1 or 2 wherein the at least five nonoverlapping paths comprise at least twenty-four nonoverlapping paths intervening between respective different pairs of adjacent magnetization regions of the plurality of magnetization regions.

12. The mover of any one of clauses 1 to 11 wherein at least one of the at least five nonoverlapping paths is radially monotonic between the reference point and the periphery.

13. The mover of any one of clauses 1 to 12 wherein each of the at least five nonoverlapping paths is radially monotonic between the reference point and the periphery.

14. The mover of any one of clauses 1 to 13 wherein substantially all or all of the at least one boundary region between adjacent magnetization regions intersects straight lines passing through the reference point and through at least one of the adjacent magnetization regions bounded by the at least one boundary region.

15. The mover of any one of clauses 1 to 14 wherein at least a portion of each boundary region between adjacent magnetization regions intersects a respective straight line passing through the reference point and through at least one of the adjacent magnetization regions bounded by the respective boundary region.

16. The mover of any one of clauses 1 to 15 wherein substantially all or all of each boundary region between adjacent magnetization regions intersects respective straight lines passing through the reference point and through at least one of the adjacent magnetization regions bounded by the respective boundary region.

17. The mover of any one of clauses 1 to 16 wherein adjacent magnetization regions of the plurality of magnetization regions comprise different magnetization directions.

18. The mover of any one of clauses 1 to 17 wherein, along at least one repetition path passing through at least some of the plurality of magnetization regions, adjacent magnetization regions of the plurality of magnetization regions comprise sequentially different respective magnetization directions in a repeating pattern.

19. The mover of clause 18 wherein the at least one repetition path is a fixed distance from the reference point.

20. The mover of clause 19 wherein the at least one repetition path is a circle.

21. The mover of any one of clauses 1 to 20 wherein the plurality of magnetization regions comprises a Halbach array.

22. The mover of any one of clauses 1 to 21 wherein at least a portion of a centerline of at least one of the plurality of magnetization regions intersects a straight line passing through the reference point at a non-zero skew angle, the centerline extending along the at least one of the plurality of magnetization regions equidistantly between a pair of adjacent ones of the at least five nonoverlapping paths bounding the at least one of the plurality of magnetization regions.

23. The mover of clause 22 wherein at least a portion of the centerline is straight.

24. The mover of clause 23 wherein all of the centerline is straight.

25. The mover of clause 22 or 23 wherein at least a portion of the centerline is curved.

26. The mover of clause 22 wherein all of the centerline is curved.

27. The mover of clause 26 wherein the centreline is arcuate.

28. The mover of any one of clauses 1 to 27 wherein at least one of the plurality of magnetization regions has no rotational symmetry.

29. The mover of any one of clauses 1 to 28 wherein at least a portion of a surface of one of the plurality of magnetization regions is non-parallel and non-perpendicular with at least another portion of a surface of the one of the plurality of magnetization regions or of another one of the plurality of magnetization regions.

30. The mover of any one of clauses 1 to 29 wherein at least one of the plurality of magnetization regions is non-rectilinear.

31. The mover of any one of clauses 1 to 30 wherein at least one of the plurality of magnetization regions is non-parallelepipedal.

32. The mover of any one of clauses 1 to 31 wherein the periphery of the plurality of magnetization regions comprises a convex hull of the plurality of magnetization regions.

33. The mover of any one of clauses 1 to 32 wherein at least a portion of the periphery is curved.

34. The mover of clause 33 wherein the periphery is substantially elliptical or elliptical within at least one plane.

35. The mover of clause 34 wherein the periphery is substantially circular or circular within the at least one plane.

36. The mover of any one of clauses 1 to 35 wherein:
the plurality of magnetization regions is between a first cylindrical surface and a second cylindrical surface concentric with the first cylindrical surface, axes of the first and second cylindrical surfaces passing through the reference point;
the first cylindrical surface has a first diameter; and
the second cylindrical surface has a second diameter greater than the first diameter.

37. The mover of clause 36 wherein the plurality of magnetization regions forms a toroid radially bounded by the first and second cylindrical surfaces.

38. The mover of any one of clauses 1 to 37 wherein the at least one actuation magnet comprises a plurality of actuation magnets.

39. The mover of clause 38 wherein at least one of the plurality of magnetization regions contains at least one of the plurality of actuation magnets.

40. The mover of clause 38 or 39 wherein each of the plurality of magnetization regions contains at least one of the plurality of actuation magnets.

41. The mover of clause 38, 39, or 40 wherein at least one of the plurality of magnetization regions contains a plurality of the plurality of actuation magnets.

42. The mover of any one of clauses 1 to 41 wherein:
the plurality of magnetization regions is a primary plurality of magnetization regions; and
the at least one actuation magnet further comprises at least one secondary plurality of magnetization regions different from the primary plurality of magnetization regions.

43. The mover of clause 42 wherein the at least one secondary plurality of magnetization regions comprises a secondary rotational plurality of magnetization regions distributed rotationally around the reference point.

44. The mover of clause 43 wherein the secondary rotational plurality of magnetization regions is coaxial with the primary plurality of magnetization regions.

45. The mover of clause 44 wherein the secondary rotational plurality of magnetization regions is radially spaced apart from the primary plurality of magnetization regions.

46. The mover of any one of clauses 42 to 45 wherein the at least one secondary plurality of magnetization regions comprises a secondary rectilinear plurality of magnetization regions arranged in a rectilinear grid.

47. The mover of clause 46 wherein the rectilinear grid is one-dimensional.

48. The mover of clause 46 or 47 wherein at least one magnetization region of the secondary rectilinear plurality of magnetization regions is rectilinear.

49. The mover of clause 46, 47, or 48 wherein each magnetization region of the secondary rectilinear plurality of magnetization regions is rectilinear.

50. The mover of any one of clauses 42 to 49, when directly or indirectly dependent from clause 38, wherein the primary plurality of magnetization regions contains at least one of the plurality of actuation magnets and the at least one secondary plurality of magnetization regions contains at least another one of the plurality of actuation magnets.

51. The mover of any one of clauses 1 to 50 further comprising a frame, wherein at least one of the at least one actuation magnet is fixed to the frame.

52. The mover of clause 51 wherein each one of the at least one actuation magnet is fixed to the frame.

53. A displacement system comprising:
a mover according to any one of clauses 1 to 52; and
a plurality of electrical conductors arranged non-circularly and positioned to generate the at least one external magnetic field.

54. A displacement system comprising:
a mover operable to move in response to at least one external magnetic field, the mover comprising:
at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction,
wherein at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions; and
a plurality of electrical conductors arranged non-circularly and positioned to generate the at least one external magnetic field.

55. The displacement system of clause 54 wherein the at least five nonoverlapping paths are in a common plane.

56. The displacement system of clause 54 or 55 wherein the at least five nonoverlapping paths comprise at least six nonoverlapping paths intervening between respective different pairs of adjacent magnetization regions of the plurality of magnetization regions.

57. The displacement system of clause 54 or 55 wherein the at least five nonoverlapping paths comprise at least seven nonoverlapping paths intervening between respective different pairs of adjacent magnetization regions of the plurality of magnetization regions.

58. The displacement system of clause 54 or 55 wherein the at least five nonoverlapping paths comprise at least eight nonoverlapping paths intervening between respective different pairs of adjacent magnetization regions of the plurality of magnetization regions.

59. The displacement system of clause 54 or 55 wherein the at least five nonoverlapping paths comprise at least nine nonoverlapping paths intervening between respective different pairs of adjacent magnetization regions of the plurality of magnetization regions.

60. The displacement system of clause 54 or 55 wherein the at least five nonoverlapping paths comprise at least ten nonoverlapping paths intervening between respective different pairs of adjacent magnetization regions of the plurality of magnetization regions.

61. The displacement system of clause 54 or 55 wherein the at least five nonoverlapping paths comprise at least twelve nonoverlapping paths intervening between respective different pairs of adjacent magnetization regions of the plurality of magnetization regions.

62. The displacement system of clause 54 or 55 wherein the at least five nonoverlapping paths comprise at least sixteen nonoverlapping paths intervening between respective different pairs of adjacent magnetization regions of the plurality of magnetization regions.

63. The displacement system of clause 54 or 55 wherein the at least five nonoverlapping paths comprise at least twenty nonoverlapping paths intervening between respective different pairs of adjacent magnetization regions of the plurality of magnetization regions.

64. The displacement system of clause 54 or 55 wherein the at least five nonoverlapping paths comprise at least twenty-four nonoverlapping paths intervening between respective different pairs of adjacent magnetization regions of the plurality of magnetization regions.

65. The displacement system of any one of clauses 54 to 64 wherein at least one of the at least five nonoverlapping paths is radially monotonic between the reference point and the periphery.

66. The displacement system of any one of clauses 54 to 65 wherein each of the at least five nonoverlapping paths is radially monotonic between the reference point and the periphery.

67. The displacement system of any one of clauses 54 to 66 wherein at least a portion of at least one boundary region between adjacent magnetization regions of the plurality of magnetization regions intersects a straight line passing through the reference point and through at least one of the adjacent magnetization regions bounded by the at least one boundary region.

68. The displacement system of clause 67 wherein substantially all or all of the at least one boundary region between adjacent magnetization regions intersects straight lines passing through the reference point and through at least one of the adjacent magnetization regions bounded by the at least one boundary region.

69. The displacement system of clause 67 or 68 wherein at least a portion of each boundary region between adjacent magnetization regions intersects a respective straight line passing through the reference point and through at least one of the adjacent magnetization regions bounded by the respective boundary region.

70. The displacement system of clause 67, 68, or 69 wherein substantially all or all of each boundary region between adjacent magnetization regions intersects respective straight lines passing through the reference point and through at least one of the adjacent magnetization regions bounded by the respective boundary region.

71. The displacement system of any one of clauses 54 to 70 wherein adjacent magnetization regions of the plurality of magnetization regions comprise different magnetization directions.

72. The displacement system of any one of clauses 54 to 71 wherein, along at least one repetition path passing through at least some of the plurality of magnetization regions, adjacent magnetization regions of the plurality of magnetization regions comprise sequentially different respective magnetization directions in a repeating pattern.

73. The displacement system of clause 72 wherein the at least one repetition path is a fixed distance from the reference point.

74. The displacement system of clause 73 wherein the at least one repetition path is a circle.

75. The displacement system of any one of clauses 54 to 74 wherein the plurality of magnetization regions comprises a Halbach array.

76. The displacement system of any one of clauses 54 to 75 wherein at least a portion of a centerline of at least one of the plurality of magnetization regions intersects a straight line passing through the reference point at a non-zero skew angle, the centerline extending along the at least one of the plurality of magnetization regions equidistantly between a pair of adjacent ones of the at least five nonoverlapping paths bounding the at least one of the plurality of magnetization regions.

77. The displacement system of clause 76 wherein at least a portion of the centerline is straight.

78. The displacement system of clause 77 wherein all of the centerline is straight.

79. The displacement system of clause 76 or 77 wherein at least a portion of the centerline is curved.

80. The displacement system of clause 76 wherein all of the centerline is curved.

81. The displacement system of clause 80 wherein the centreline is arcuate.

82. The displacement system of any one of clauses 54 to 81 wherein at least one of the plurality of magnetization regions has no rotational symmetry.

83. The displacement system of any one of clauses 54 to 82 wherein at least a portion of a surface of one of the plurality of magnetization regions is non-parallel and non-perpendicular with at least another portion of a surface of one of the plurality of magnetization regions.

84. The displacement system of any one of clauses 54 to 83 wherein at least one of the plurality of magnetization regions is non-rectilinear.

85. The displacement system of any one of clauses 54 to 84 wherein at least one of the plurality of magnetization regions is non-parallelepipedal.

86. The displacement system of any one of clauses 54 to 85 wherein the periphery of the plurality of magnetization regions comprises a convex hull of the plurality of magnetization regions.

87. The displacement system of any one of clauses 54 to 86 wherein at least a portion of the periphery is curved.

88. The displacement system of clause 87 wherein the periphery is substantially elliptical or elliptical within at least one plane.

89. The displacement system of clause 88 wherein the periphery is substantially circular or circular within the at least one plane.

90. The displacement system of any one of clauses 54 to 89 wherein:
the plurality of magnetization regions is between a first cylindrical surface and a second cylindrical surface concentric with the first cylindrical surface, axes of the first and second cylindrical surfaces passing through the reference point;
the first cylindrical surface has a first diameter; and
the second cylindrical surface has a second diameter greater than the first diameter.

91. The displacement system of clause 90 wherein the plurality of magnetization regions forms a toroid radially bounded by the first and second cylindrical surfaces.

92. The displacement system of any one of clauses 54 to 91 wherein the at least one actuation magnet comprises a plurality of actuation magnets.

93. The displacement system of clause 92 wherein at least one of the plurality of magnetization regions contains at least one of the plurality of actuation magnets.

94. The displacement system of clause 92 or 93 wherein each of the plurality of magnetization regions contains at least one of the plurality of actuation magnets.

95. The displacement system of clause 92, 93, or 94 wherein at least one of the plurality of magnetization regions contains a plurality of the plurality of actuation magnets.

96. The displacement system of any one of clauses 54 to 95 wherein:
the plurality of magnetization regions is a primary plurality of magnetization regions; and
the at least one actuation magnet further comprises at least one secondary plurality of magnetization regions different from the primary plurality of magnetization regions.

97. The displacement system of clause 96 wherein the at least one secondary plurality of magnetization regions comprises a secondary rotational plurality of magnetization regions distributed rotationally around the reference point.

98. The displacement system of clause 97 wherein the secondary rotational plurality of magnetization regions is coaxial with the primary plurality of magnetization regions.

99. The displacement system of clause 98 wherein the secondary rotational plurality of magnetization regions is radially spaced apart from the primary plurality of magnetization regions.

100. The displacement system of any one of clauses 96 to 99 wherein the at least one secondary plurality of magnetization regions comprises a secondary rectilinear plurality of magnetization regions arranged in a rectilinear grid.

101. The displacement system of clause 100 wherein the rectilinear grid is one-dimensional.

102. The displacement system of clause 100 or 101 wherein at least one magnetization region of the secondary rectilinear plurality of magnetization regions is rectilinear.

103. The displacement system of clause 100, 101, or 102 wherein each magnetization region of the secondary rectilinear plurality of magnetization regions is rectilinear.

104. The displacement system of any one of clauses 96 to 103, when directly or indirectly dependent from clause 92, wherein the primary plurality of magnetization regions contains at least one of the plurality of actuation magnets and the at least one secondary plurality of magnetization regions contains at least another one of the plurality of actuation magnets.

105. The displacement system of any one of clauses 54 to 104 wherein:
the mover further comprise a frame; and
at least one of the at least one actuation magnet is fixed to the frame.

106. The displacement system of clause 105 wherein each of the at least one actuation magnet is fixed to the frame.

107. The displacement system of any one of clauses 53 to 106 wherein the plurality of electrical conductors are arranged along a rectilinear spacing grid.

108. The displacement system of clause 107 wherein the rectilinear spacing grid is a Cartesian grid.

109. The displacement system of clause 107 or 108 wherein the rectilinear spacing grid is two-dimensional.

110. The displacement system of any one of clauses 53 to 109 wherein the plurality of electrical conductors comprises:
a first plurality of electrical conductors extending in a first direction, at least some of the first plurality of electrical conductors spaced apart from one another in a second direction nonparallel to the first direction; and
a second plurality of electrical conductors extending in a third direction nonparallel to the first direction, at least some of the second plurality of electrical conductors spaced apart from one another in a fourth direction nonparallel to the third direction.

111. The displacement system of clause 110 wherein the first direction is generally perpendicular to the second direction.

112. The displacement system of clause 110 or 111 wherein the third direction is generally perpendicular to the fourth direction.

113. The displacement system of clause 110, 111, or 112 wherein the second direction is generally parallel to the third direction.

114. The displacement system of any one of clauses 110 to 113 wherein the first direction is generally parallel to the fourth direction.

115. The displacement system of any one of clauses 110 to 114 wherein the first, second, third, and fourth directions are generally in a common plane.

116. The displacement system of any one of clauses 110 to 115 wherein at least three of the first plurality of electrical conductors are spaced apart from one another in the second direction.

117. The displacement system of any one of clauses 110 to 116 wherein at least three of the second plurality of electrical conductors are spaced apart from one another in the fourth direction.

118. The displacement system of any one of clauses 110 to 117 wherein a first conductor-second direction spacing in the second direction between adjacent ones of the first plurality of electrical conductors spaced apart in the second direction is substantially constant or constant.

119. The displacement system of any one of clauses 110 to 118 wherein a second conductor-fourth direction spacing in the fourth direction between adjacent ones of the second plurality of electrical conductors spaced apart in the fourth direction is substantially constant or constant.

120. The displacement system of clause 119, when dependent from clause 118, wherein the second conductor-fourth direction spacing is substantially equal or equal to the first conductor-second direction spacing.

121. The displacement system of any one of clauses 110 to 120 wherein at least some of the first plurality of conductors are spaced apart from one another in the first direction.

122. The displacement system of clause 121 wherein a first conductor-first direction spacing in the first direction between adjacent ones of the first plurality of conductors spaced apart in the first direction is substantially constant or constant.

123. The displacement system of any one of clauses 110 to 122 wherein at least some of the second plurality of conductors are spaced apart from one another in the third direction.

124. The displacement system of clause 123 wherein a second conductor-third direction spacing in the third direction between adjacent ones of the second plurality of electrical conductors spaced apart in the third direction is substantially constant or constant.

125. The displacement system of clause 124, when dependent from clause 122, wherein the first conductor-first direction spacing is substantially equal or equal to the second conductor-third direction spacing.

126. The displacement system of any one of clauses 110 to 125 wherein each of the first plurality of electrical conductors has a fixed first conductor length in the first direction.

127. The displacement system of clause 126, when directly or indirectly dependent from clause 36 or clause 90, wherein the first diameter is greater than 80 percent of the first conductor length.

128. The displacement system of clause 127 wherein the first diameter is greater than 90 percent of the first conductor length.

129. The displacement system of clause 127 or 128, wherein the first diameter is greater than the first conductor length.

130. The displacement system of any one of clauses 126 to 129, when directly or indirectly dependent from clause 36 or clause 90, wherein the second diameter is greater than the first conductor length.

131. The displacement system of any one of clauses 110 to 130 wherein each of the second plurality of electrical conductors has a fixed second conductor length in the third direction.

132. The displacement system of clause 131, when directly or indirectly dependent from clause 36 or clause 90, wherein the first diameter is greater than 80 percent of the second conductor length.

133. The displacement system of clause 132 wherein the first diameter is greater than 90 percent of the second conductor length.

134. The displacement system of clause 132 or 133, wherein the first diameter is greater than the second conductor length.

135. The displacement system of any one of clauses 131 to 134, when directly or indirectly dependent from clause 36 or clause 90, wherein the second diameter is greater than the second conductor length.

136. The displacement system of any one of clauses 131 to 135, when directly or indirectly dependent from clause 126, wherein the first conductor length is substantially equal or equal to the second conductor length.

137. The displacement system of any one of clauses 53 to 136 wherein the plurality of electrical conductors comprises a plurality of coils.

138. The displacement system of any one of clauses 53 to 137 further comprising a stator comprising the plurality of electrical conductors.

139. The displacement system of clause 138 further comprising a controller configured to control the stator to generate the at least one external magnetic field.

140. The displacement system of any one of clauses 53 to 139, wherein:
at least a portion of a first magnetization region of the plurality of magnetization regions is configured to align with a first electrical conductor of the plurality of electrical conductors; and
at least a portion of a second magnetization region of the plurality of magnetization regions is configured to align with a second electrical conductor of the plurality of electrical conductors when the at least a portion of the first magnetization region aligns with the first electrical conductor.

141. The displacement system of clause 140 wherein the first magnetization region and the second magnetization region are diametrically opposite one another around the reference point.

142. The displacement system of clause 140 wherein the first magnetization region is adjacent to the second magnetization region.

143. The displacement system of clause 140, 141, or 142 wherein at least a portion of a third magnetization region of the plurality of magnetization regions is configured to align with a third electrical conductor of the plurality of electrical conductors when the at least a portion of the first magnetization region aligns with the first electrical conductor and the at least a portion of the second magnetization region aligns with the second electrical conductor.

144. The displacement system of clause 143 wherein the second magnetization region is adjacent to the third magnetization region.

145. The displacement system of clause 143 or 144 wherein the third magnetization region is diametrically opposite from the first magnetization region.

146. The displacement system of clause 143, 144, or 145 wherein at least a portion of a fourth magnetization region of the plurality of magnetization regions is configured to align with a fourth electrical conductor of the plurality of electrical conductors when the at least a portion of the first magnetization region aligns with the first electrical conductor, the at least a portion of the second magnetization region aligns with the second electrical conductor, and the at least a portion of the third magnetization region aligns with the third electrical conductor.

147. The displacement system of clause 146 wherein the third magnetization region is adjacent to the fourth magnetization region.

148. The displacement system of clause 146 or 147 wherein the fourth magnetization region is diametrically opposite from the second magnetization region.

149. The mover of any one of clauses 1 to 52 or the displacement system of any one of clauses 53 to 148 wherein the magnetization regions of the plurality of magnetization regions are rotationally distributed around the reference point with a first angular period.

150. The mover or the displacement system of clause 149 wherein the plurality of magnetization regions is substantially rotationally symmetric with a period of the first angular period.

151. The mover or the displacement system of clause 150 wherein the plurality of magnetization regions is rotationally symmetric with the period of the first angular period.

152. The mover or the displacement system of clause 149, 150, or 151 wherein the plurality of magnetization regions is substantially rotationally anti-symmetric.

153. The mover or the displacement system of clause 152 wherein the plurality of magnetization regions is rotationally anti-symmetric.

154. The mover or the displacement system of clause 152, wherein the plurality of magnetization regions is substantially rotationally anti-symmetric with a period of half the first angular period.

155. The mover or the displacement system of clause 152, 153, or 154 wherein the plurality of magnetization regions is rotationally anti-symmetric with a period of half the first angular period.

Although specific embodiments have been described and illustrated, such embodiments should be considered illustrative only and not as limiting the invention as construed according to the accompanying claims.

1. A mover operable to move in response to at least one external magnetic field, the mover comprising:
at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction,
wherein:
at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions;
at least a portion of at least one boundary region between adjacent magnetization regions of the plurality of magnetization regions intersects a straight line passing through the reference point and through at least one of the adjacent magnetization regions bounded by the at least one boundary region; and
at least a portion of a centerline of at least one of the plurality of magnetization regions intersects a straight line passing through the reference point at a non-zero skew angle, the centerline extending along the at least one of the plurality of magnetization regions equidistantly between a pair of adjacent ones of the at least five nonoverlapping paths bounding the at least one of the plurality of magnetization regions.

2. A displacement system comprising:
a mover operable to move in response to at least one external magnetic field, the mover comprising:
at least one actuation magnet configured to generate forces for moving the mover in response to the at least one external magnetic field, the at least one actuation magnet comprising a plurality of magnetization regions distributed rotationally around a reference point of the mover, each magnetization region of the plurality of magnetization regions comprising a respective magnetization direction,
wherein at least five nonoverlapping paths intervene between respective different pairs of adjacent magnetization regions of the plurality of magnetization regions, the magnetization regions of each of the pairs of adjacent magnetization regions comprising respective magnetization directions different from each other, each nonoverlapping path of the at least five nonoverlapping paths extending from the reference point to a periphery of the plurality of magnetization regions; and
a plurality of electrical coils arranged non-circularly and positioned to generate the at least one external magnetic field in response to at least one current driven into the plurality of electrical coils.

3-5. (canceled)

6. The displacement system of claim 2 wherein at least a portion of at least one boundary region between adjacent magnetization regions of the plurality of magnetization regions intersects a straight line passing through the reference point and through at least one of the adjacent magnetization regions bounded by the at least one boundary region.

7. The displacement system of claim 2 wherein adjacent magnetization regions of the plurality of magnetization regions comprise different magnetization directions.

8. The displacement system of claim 2 wherein at least a portion of a centerline of at least one of the plurality of magnetization regions intersects a straight line passing through the reference point at a non-zero skew angle, the centerline extending along the at least one of the plurality of magnetization regions equidistantly between a pair of adjacent ones of the at least five nonoverlapping paths bounding the at least one of the plurality of magnetization regions.

9-12. (canceled)

13. The displacement system of claim 2 wherein the plurality of electrical coils comprises:
a first plurality of electrical coils extending in a first direction, at least some of the first plurality of electrical coils spaced apart from one another in a second direction nonparallel to the first direction; and
a second plurality of electrical coils extending in a third direction nonparallel to the first direction, at least some of the second plurality of electrical coils spaced apart from one another in a fourth direction nonparallel to the third direction.

14. The displacement system of claim 13 wherein the first, second, third, and fourth directions are generally in a common plane.

15. The displacement system of claim 13 wherein at least some of the first plurality of coils are spaced apart from one another in the first direction.

16. The displacement system of claim 13 wherein at least some of the second plurality of coils are spaced apart from one another in the third direction.

17. The displacement system of claim 13 wherein each of the first plurality of electrical coils has a fixed first conductor length in the first direction.

18. The displacement system of claim 17 wherein:
the plurality of magnetization regions is between a first cylindrical surface and a second cylindrical surface concentric with the first cylindrical surface, axes of the first and second cylindrical surfaces passing through the reference point;
the first cylindrical surface has a first diameter;
the second cylindrical surface has a second diameter greater than the first diameter; and
the first diameter is greater than 80 percent of the first conductor length.

19. The displacement system of claim 17 wherein each of the second plurality of electrical coils has a fixed second conductor length in the third direction.

20. The displacement system of claim 18, wherein:
each of the second plurality of electrical coils has a fixed second conductor length in the third direction; and
the first diameter is greater than 80 percent of the second conductor length.

21. The displacement system of claim 2 wherein, along at least one repetition path passing through at least some of the plurality of magnetization regions, adjacent magnetization regions of the plurality of magnetization regions comprise sequentially different respective magnetization directions in a repeating pattern.

22. The displacement system of claim 21 wherein the at least one repetition path is a fixed distance from the reference point.

23. The displacement system of claim 2 wherein the plurality of magnetization regions comprises a Halbach array.

24. The displacement system of claim 8 wherein at least a portion of the centerline is straight.

25. The displacement system of claim 8 wherein at least a portion of the centerline is curved.

26. The displacement system of claim 2 wherein at least one of the plurality of magnetization regions has no rotational symmetry.

27. The displacement system of claim 2 wherein:
the magnetization regions of the plurality of magnetization regions are rotationally distributed around the reference point with a first angular period; and
the plurality of magnetization regions is substantially rotationally anti-symmetric.

28. The displacement system of claim 27 wherein the plurality of magnetization regions is substantially rotationally anti-symmetric with a period of half the first angular period.

29. The mover of claim 1 wherein, along at least one repetition path passing through at least some of the plurality of magnetization regions, adjacent magnetization regions of the plurality of magnetization regions comprise sequentially different respective magnetization directions in a repeating pattern.

30. The mover of claim 29 wherein the at least one repetition path is a fixed distance from the reference point.

31. The mover of claim 1 wherein the plurality of magnetization regions comprises a Halbach array.

32. The mover of claim 1 wherein at least a portion of the centerline is straight.

33. The mover of claim 1 wherein at least a portion of the centerline is curved.

34. The mover of claim 1 wherein at least one of the plurality of magnetization regions has no rotational symmetry.

35. The mover of claim 1 wherein:
the magnetization regions of the plurality of magnetization regions are rotationally distributed around the reference point with a first angular period; and
the plurality of magnetization regions is substantially rotationally anti-symmetric.

36. The mover of claim 35 wherein the plurality of magnetization regions is substantially rotationally anti-symmetric with a period of half the first angular period.
